(19) United States
(12) Patent Application Publication
(10) Pub. No.: US 2012/0287760 A1
(43) Pub. Date: Nov. 15, 2012

(54) STEPPING MOTOR CONTROL CIRCUIT AND ANALOG ELECTRONIC TIMEPIECE

(76) Inventors: Kenji OGASAWARA, Chiba-shi (JP); Toshitaka Fukushim, Chiba-shi (JP); Saburo Manaka, Chiba-shi (JP); Akira Takakura, Chiba-shi (JP); Hiroshi Shimizu, Chiba-shi (JP); Kazumi Sakumoto, Chiba-shi (JP); Keishi Honmura, Chiba-shi (JP); Kosuke Yamamoto, Chiba-shi (JP)

(21) Appl. No.: 13/466,749

(22) Filed: May 8, 2012

(30) Foreign Application Priority Data
May 12, 2011 (JP) 2011-107607
May 12, 2011 (JP) 2011-107608
May 12, 2011 (JP) 2011-107609
Feb. 27, 2012 (JP) 2012-040426

(51) Int. Cl. H02P 8/00; G04B 19/04

(52) U.S. Cl. 368/80; 318/696

(57) ABSTRACT

A voltage detection circuit detects a voltage of a secondary cell that powers a stepping motor. A rotation detection circuit detects a rotation state of the stepping motor, and a control unit selects a main driving pulse for driving the stepping motor based on the detected rotation state from plural kinds of driving pulses having different energies. An analog display unit announces that the voltage of the secondary cell becomes a predetermined reference voltage when the voltage detection circuit detects that the voltage of the secondary cell becomes the predetermined reference voltage. When the control unit selects a predetermined main driving pulse before the voltage detection circuit detects that the voltage of the secondary cell becomes a current reference voltage, the control unit sets the reference voltage to the predetermined reference voltage higher than the current reference voltage.

### BACKGROUND OF THE INVENTION

1. Field of the Invention

The present invention relates to a stepping motor control circuit using a secondary cell as a power supply and an analog electronic timepiece using the stepping motor control circuit.

2. Background Art

Hitherto, analog electronic timepieces have been developed which use a secondary cell as a power supply and are charged by power generation means such as a solar cell. In the analog electronic timepieces including the power generation means according to the related art, plural kinds of motor driving pulses different from each other in energy are provided and the motor driving pulses are switched in accordance with the detected voltages of the secondary cell (for example, see JP-A-62-238484).

When the detected voltage of the secondary cell is lowered to an over-discharge voltage, the voltage of the secondary cell becomes a voltage close to the lower limit of a driving voltage by which a motor is rotatable. When the state of the voltage close to the lower limit continues, there is a concern that driving may not be possible. Therefore, when the voltage of the secondary cell is lowered to the over-discharge voltage, a user is informed of the lowering of the voltage of the secondary cell by switching driving from driving by a main driving pulse to driving by an irregular pointer movement pulse and by moving a time hand in a pattern different from a normal pattern by the irregular pointer movement pulse. The irregular pointer movement pulse is a driving pulse with energy greater than a main driving pulse P1, and thus the power consumption may increase.

On the other hand, there is no problem when the rotation driving can be performed up to the over-discharge voltage by the main driving pulse P1. However, when the rotation driving may not be performed, the driving is performed by a correction driving pulse P2 with energy greater than the main driving pulse P1. Accordingly, a problem may arise in that the secondary cell is consumed dramatically, and thus the time in which the voltage becomes the over-discharge voltage passes quickly.

### SUMMARY OF THE INVENTION

It is an aspect of the present application to provide a technique of suppressing unnecessary energy consumption by avoiding driving by a correction driving pulse as far as possible.

According to the aspect of the application, a stepping motor control circuit includes: a secondary cell serving as a power supply that supplies power at least to a stepping motor; voltage detection means for detecting a voltage of the secondary cell; rotation detection means for detecting a rotation state of the stepping motor; control means for selecting a driving pulse of an energy corresponding to the rotation state of the stepping motor from plural kinds of driving pulses and driving the stepping motor in a predetermined pattern; and announcement means for announcing that the voltage of the secondary cell becomes a predetermined reference voltage when the voltage detection means detects that the voltage of the secondary cell becomes the predetermined reference voltage. When the control means drives the stepping motor in the predetermined pattern before the voltage detection means detects that the voltage of the secondary cell becomes a current reference voltage, the control means sets the reference voltage to the predetermined reference voltage higher than the current reference voltage.

According to another aspect of the application, an analog electronic timepiece includes: a stepping motor rotatably driving a time hand; and a stepping motor control circuit controlling the stepping motor. The stepping motor control circuit is the stepping motor control circuit according to the above aspect of the invention.

In the stepping motor control circuit according to the application, the driving by the correction driving pulse can be avoided as far as possible, and thus unnecessary energy consumption can be suppressed.

According to the analog electronic timepiece according to the application, the driving by the correction driving pulse can be avoided as far as possible, and thus unnecessary energy consumption can be suppressed.

### BRIEF DESCRIPTION OF THE DRAWINGS

FIG. 1 is a common block diagram illustrating an analog electronic timepiece that uses a stepping motor control circuit according to first to fifth embodiments and eighth to eleventh embodiments of the invention.

FIG. 2 is a flowchart illustrating a stepping motor control circuit and an analog electronic timepiece according to a first embodiment of the invention.

FIG. 3 is a flowchart illustrating a stepping motor control circuit and an analog electronic timepiece according to a second embodiment of the invention.

FIG. 4 is a flowchart illustrating a stepping motor control circuit and an analog electronic timepiece according to a third embodiment of the invention.

FIG. 5 is a flowchart illustrating a stepping motor control circuit and an analog electronic timepiece according to a fourth embodiment of the invention.

FIG. 6 is a flowchart illustrating a stepping motor control circuit and an analog electronic timepiece according to a fifth embodiment of the invention.

FIG. 7 is a common block diagram illustrating an analog electronic timepiece that uses a stepping motor control circuit according to sixth, seventh, twelfth, and thirteenth embodiments of the invention.

FIG. 8 is a diagram illustrating timings of the stepping motor control circuit and the analog electronic timepiece according to the sixth, seventh, twelfth, and thirteenth embodiments of the invention.

FIG. 9 is a common diagram illustrating a determination chart in the stepping motor control circuit and the analog electronic timepiece according to the sixth, seventh, twelfth, and thirteenth embodiments of the invention.

FIG. 10 is a flowchart illustrating a stepping motor control circuit and an analog electronic timepiece according to the sixth embodiment of the invention.

FIG. 11 is a flowchart illustrating a stepping motor control circuit and an analog electronic timepiece according to the seventh embodiment of the invention.

FIG. 12 is a flowchart illustrating a stepping motor control circuit and an analog electronic timepiece according to the eighth embodiment of the invention.

FIG. 13 is a flowchart illustrating a stepping motor control circuit and an analog electronic timepiece according to the ninth embodiment of the invention.

FIG. 14 is a flowchart illustrating a stepping motor control circuit and an analog electronic timepiece according to the tenth embodiment of the invention.

FIG. 15 is a flowchart illustrating a stepping motor control circuit and an analog electronic timepiece according to the eleventh embodiment of the invention.

FIG. 16 is a flowchart illustrating a stepping motor control circuit and an analog electronic timepiece according to the twelfth embodiment of the invention.

FIG. 17 is a flowchart illustrating a stepping motor control circuit and an analog electronic timepiece according to the thirteenth embodiment of the invention.

### DETAILED DESCRIPTION OF THE INVENTION

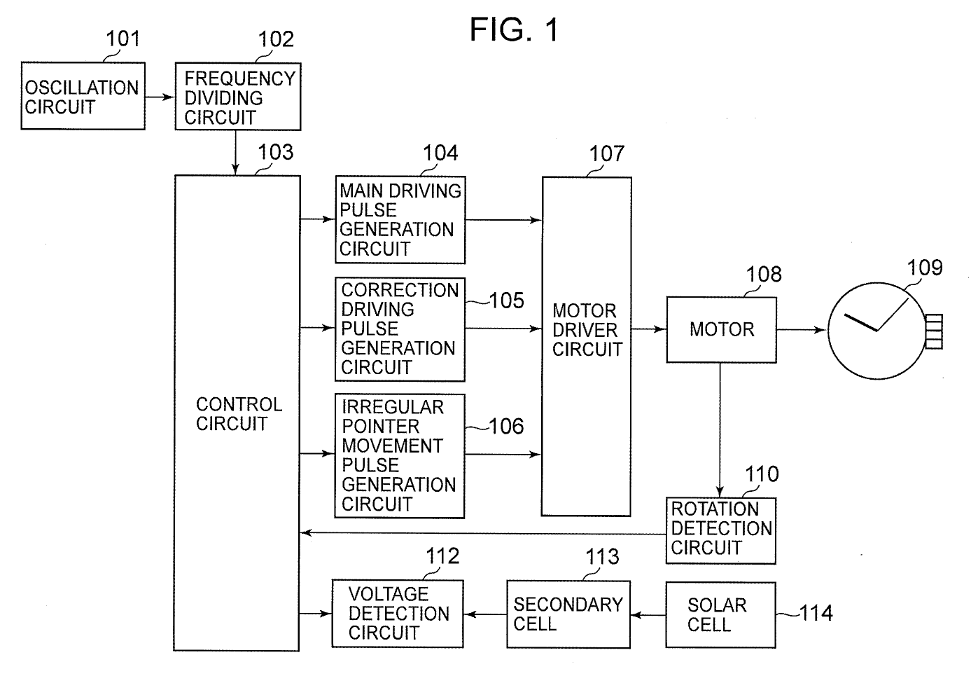

FIG. 1 is a common block diagram illustrating an analog electronic timepiece that uses a stepping motor control circuit according to first to fifth embodiments and eighth to eleventh embodiments of the invention. FIG. 1 shows an example of an analog electronic wristwatch.

In FIG. 1, the analog electronic timepiece includes an oscillation circuit 101 that generates a signal with a predetermined frequency; a frequency dividing circuit 102 that divides the signal generated by the oscillation circuit 101 and generates a timepiece signal serving as a reference of time measurement; and a control circuit 103 that performs a time measurement process of the timepiece signal or various kinds of control such as control of each electronic circuit element of the analog electronic timepiece and change control of a driving pulse.

The analog electronic timepiece further includes a main driving pulse generation circuit 104 that selects and outputs a main driving pulse among plural kinds of main driving pulses P1 different from each other in energy based on a main driving pulse control signal from the control circuit 103; a correction driving pulse generation circuit 105 that outputs a correction driving pulse P2 with an energy greater than each of the main driving pulses P1 based on a correction driving pulse control signal from the control circuit 103; and an irregular pointer movement pulse generation circuit 106 that outputs an irregular pointer movement pulse Ph based on an irregular pointer movement pulse control signal from the control circuit 103.

In the embodiments, plural kinds of driving pulses are provided as driving pulses used to rotatably drive a stepping motor 108. The plural kinds (that is, plural ranks) of main driving pulses P1 different from each other in energy, the irregular pointer movement pulse Ph, and the correction diving pulse P2 with a large energy to the degree that the steeping motor can be forcibly rotated when the stepping motor may not be rotated by the main driving pulses P1 are used as the driving pulses.

The irregular pointer movement pulse Ph is a driving pulse that has an energy greater than each of the main driving pulses P1 and smaller than the sum of one main driving pulse P1 and the correction driving pulse P2 (where the main driving pulse P1<the irregular pointer movement pulse Ph<(the main driving pulse P1+the correction driving pulse P2)). Further, one of the main driving pulses P1 may be used as the irregular pointer movement pulse Ph.

The analog electronic timepiece further includes a motor driver circuit 107 that rotatably drives the stepping motor 108 in response to the main driving pulses P1 from the main driving pulse generation circuit 104, the correction driving pulse P2 from the correction driving pulse generation circuit 105, and the irregular pointer movement pulse Ph from the irregular pointer movement pulse generation circuit 106.

The analog electronic timepiece further includes a stepping motor 108 that is rotatably driven by the motor driver circuit 107; an analog display unit 109 that includes a display unit displaying time hands for time display or a calendar rotatably driven by the stepping motor 108; and a rotation detection circuit 110 that detects an induction signal VRs generated by the stepping motor 108 in a predetermined rotation detection section and outputs a detection signal indicating a rotation state.

The analog electronic timepiece further includes a secondary cell 113 serving as a power supply supplying power first to the stepping motor 108 and each electronic circuit element of the analog electronic timepiece, a solar cell 114 that charges the secondary cell 113, and a voltage detection circuit 112 that detects the voltage of the secondary cell 113. The secondary cell 113 functions as the power supply supplying the power to at least the stepping motor 108.

The oscillation circuit 101 and the frequency dividing circuit 102 form signal generation means. The analog display unit 109 forms announcement means. The rotation detection circuit 110 forms rotation detection means. The solar cell 114 forms power generation means for generating power and also forms charging means for charging the secondary cell 113. The main driving pulse generation circuit 104, the correction driving pulse generation circuit 105, and the irregular pointer movement pulse generation circuit 106 form driving pulse generation means. The oscillation circuit 101, the frequency dividing circuit 102, the control circuit 103, the main driving pulse generation circuit 104, the correction driving pulse generation circuit 105, the irregular pointer movement pulse generation circuit 106, and the motor driver circuit 107 form control means. The oscillation circuit 101, the frequency dividing circuit 102, the control circuit 103, the main driving pulse generation circuit 104, the correction driving pulse generation circuit 105, the irregular pointer movement pulse generation circuit 106, the motor driver circuit 107, the rotation detection circuit 110, the voltage detection circuit 112, the secondary cell 113, and the solar cell 114 form a stepping motor control circuit.

The solar cell 114 generates power to charge the secondary cell 113. The secondary cell 113 serving as the power supply supplies the power first to the stepping motor 108 and the circuit elements of the analog electronic timepiece, so that the analog electronic timepiece operates.

Each time display operation of a normal operation of the analog electronic timepiece will be described in brief with reference to FIG. 1. The oscillation circuit 101 generates a signal with a predetermined frequency and the frequency dividing circuit 102 divides the signal generated by the oscillation circuit 101, generates a timepiece signal (for example, a signal with a period of 1 second) serving as a reference of the time measurement, and outputs the timepiece signal to the control circuit 103.

The control circuit 103 outputs a main driving pulse control signal to the main driving pulse generation circuit 104 in a predetermined period in response to the timepiece signal based on the rotation detection result of the stepping motor 108 by the rotation detection circuit 110, so that the stepping motor 108 can be rotatably driven by the main driving pulse P1 of an energy rank corresponding to the magnitude of a load or the voltage of the secondary cell 113.

The main driving pulse P1 is a driving pulse used to rotatably drive the stepping motor 108 when time hands (second, minute, and hour pointers) are moved in a normal operation. The correction driving pulse P2 is a driving pulse used to forcibly rotate the stepping motor 108 when the stepping motor 108 may not be rotated by the main driving pulse P1. When the time hands are moved in the normal operation, the stepping motor 108 is driven once in each predetermined time (for example, one second) (first pattern). The irregular pointer movement pulse is a driving pulse used to drive the movement of the time hands in a second pattern (for example, the stepping motor 108 performs driving of irregular pointer movement corresponding to two seconds every two seconds (two-second pointer movement)) different from the first pattern.

The main driving pulse generation circuit 104 outputs, to the motor driver circuit 107, the main driving pulse P1 of the energy rank corresponding to the main driving pulse control signal from the control circuit 103. The motor driver circuit 107 rotatably drives the stepping motor 108 by the main driving pulses P1. The stepping motor 108 is rotatably driven by the main driving pulses P1, so that the stepping motor 108 rotatably drives the time hands of the analog display unit 109. Thus, when the stepping motor 108 is normally rotated, the current time is displayed by the time hands in the analog display unit 109.

The rotation detection circuit 110 detects a detection signal VRs with a voltage exceeding a predetermined reference threshold voltage Vcomp among the induction signals VRs caused by rotation free oscillation of the stepping motor 108 in a predetermined detection section T.

The rotation detection circuit 110 is configured to detect the detection signal VRs with the voltage exceeding the predetermined reference threshold voltage Vcomp, when the stepping motor 108 is rotated. On the other hand, the rotation detection circuit 110 is configured not to detect the induction signal VRs with the voltage exceeding the predetermined reference threshold voltage Vcomp, when the stepping motor 108 is not rotated. The rotation detection circuit 110 outputs, to the control circuit 103, a detection signal indicating whether the induction signal VRs with the voltage exceeding the reference threshold voltage Vcomp is detected, that is, a detection signal indicating whether the stepping motor 108 is rotated.

When the rotation detection circuit 110 detects that the stepping motor 108 is rotated, the control circuit 103 outputs a control signal to the main driving pulse generation circuit 104 so that the stepping motor 108 is driven by the main driving pulse P1 with the same energy as the energy of the previous driving time at the subsequent driving time. The main driving pulse generation circuit 104 generates the main driving pulse P1 which is the same as that of the previous main driving pulse in response to the control signal so that the stepping motor 108 is driven by this main driving pulse P1.

On the other hand, when the rotation detection circuit 110 detects that the stepping motor 108 is not rotated, the control circuit 103 outputs a control signal to the correction driving pulse generation circuit 105 so that the stepping motor 108 is driven by the correction driving pulse P2. The correction driving pulse generation circuit 105 generates the correction driving pulse P2 in response to the control signal so that the motor driver circuit 107 drives the stepping motor 108. Thus, the stepping motor 108 is forcibly rotated.

When the rotation detection circuit 110 detects that the stepping motor 108 is not rotated, the control circuit 103 outputs a control signal to the main driving pulse generation circuit 104 at the subsequent driving time so that the stepping motor 108 is rotated by the main driving pulse P1 with an energy increased by one rank from the previous main driving pulse P1. The main driving pulse generation circuit 104 generates the main driving pulse P1 with an energy increasing by one rank in response to the control signal so that the stepping motor 108 is driven by this main driving pulse P1. Thus, reliable rotation can be realized at the subsequent driving time.

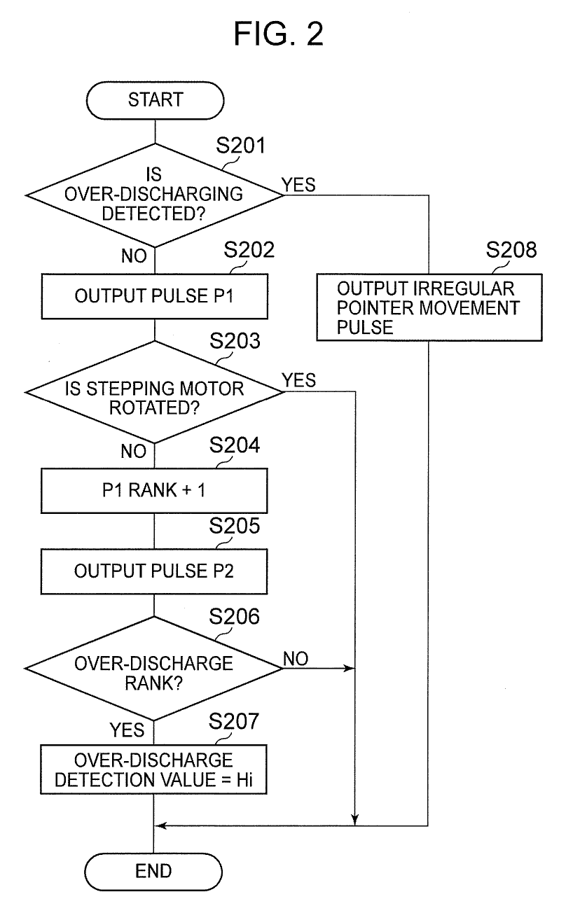

FIG. 2 is a flowchart illustrating the operations of the stepping motor control circuit and the analog electronic timepiece according to a first embodiment of the invention and is a flowchart mainly illustrating an operation when the control circuit 103 controls setting of an over-discharge detection value or the driving of the irregular pointer movement.

Hereinafter, an operation according to the first embodiment of the invention will be described in detail with reference to FIGS. 1 and 2.

The control circuit 103 controls the voltage detection circuit 112 such that the voltage detection circuit 112 detects the voltage of the secondary cell 113, when the stepping motor 108 is driven by the main driving pulse P1 in the first pattern of the period of one second to move the time hands.

The control circuit 103 determines whether the voltage detection circuit 112 detects a predetermined over-discharge voltage (over-discharge detection value) (step S201).

Here, the over-discharge detection value is a predetermined reference voltage used to determine whether the voltage of the secondary cell 113 is lowered to a predetermined voltage (the voltage of an over-discharge region).

The fact that the voltage detection circuit 112 detects the over-discharge detection value means that the voltage of the secondary cell 113 is lowered to the predetermined voltage (the voltage of the over-discharge region), and thus means that the voltage of the secondary cell 113 is lowered to a state where it is difficult to rotatably drive the stepping motor 108 normally only by the main driving pulse P1.

When the voltage of the secondary cell 113 is lowered to the over-discharge detection value, the stepping motor 108 may not be rotated by the main driving pulse P1, and thus is frequently driven by the correction driving pulse P2.

In the first embodiment, a plurality of reference voltages are provided as the over-discharge detection values. That is, two kinds of reference voltages are provided: a first reference voltage (Lo) which is a predetermined low voltage and a second reference voltage (Hi) which is a predetermined high voltage higher than the first reference voltage. These reference voltages are switched and set as the reference voltages used to detect whether the secondary cell 113 is in the over-discharge region. In the initial state, the over-discharge detection value of the first reference voltage is set.

When the control circuit 103 determines that the voltage detection circuit 112 detects the over-discharge detection value, that is, determines that the voltage of the secondary cell 113 is lowered to the first reference voltage (step S201), the control circuit 103 outputs an irregular pointer movement pulse control signal to the irregular pointer movement pulse generation circuit 106 so that irregular pointer movement is performed (step S208).

The irregular pointer movement pulse generation circuit 106 outputs the irregular pointer movement pulse Ph to the motor driver circuit 107 in response to the irregular pointer movement pulse control signal. The motor driver circuit 107 drives the stepping motor 108 by the irregular pointer movement pulse Ph to perform the irregular pointer movement in the second pattern different from the first pattern. For example, the second pattern can be configured as a pattern in which the stepping motor 108 performs the driving of the irregular pointer movement corresponding to two seconds every two seconds (two-second pointer movement).

When such irregular pointer movement is performed, a user is informed of the fact that the voltage of the secondary cell 113 is lowered to the predetermined voltage (the voltage of the over-discharge region) which is the driving limit. The user can reliably operate the analog electronic timepiece by radiating the solar cell 114 with solar light to generate power and charging the secondary cell 113 with the solar light.

When the voltage of the secondary cell 113 is lowered to a voltage equal to or less than the predetermined voltage, the stepping motor 108 is not rotated by the main driving pulse P1, but is rotated by the correction driving pulse P2, thereby increasing the power consumption. In the first embodiment, however, the user is informed of the lowering of the voltage by performing the irregular pointer movement when the voltage of the secondary cell 113 is lowered to the predetermined voltage, and charging is prompted. Therefore, since the number of times of driving by the correction driving pulse P2 can be reduced, lower power consumption can be realized.

When the control circuit 103 determines that the voltage detection circuit 112 does not detect the over-discharge value in step S201, the control circuit 103 outputs the control signal to the main driving pulse generation circuit 104 so that the main driving pulse generation circuit 104 outputs the main driving pulse 21 (step S202). The main driving pulse generation circuit 104 outputs the main driving pulse P1 with the energy corresponding to the control signal to the motor driver circuit 107, and the motor driver circuit 107 drives the stepping motor 108 by this main driving pulse P1.

The rotation detection circuit 110 detects the induction signal VRs generated by the rotation free oscillation of the stepping motor 108 in the rotation detection section T and outputs, to the control circuit 103, a detection signal indicating whether the induction signal VRs exceeding the reference threshold voltage Vcomp is detected, that is, whether the stepping motor 108 is rotated.

The control circuit 103 determines whether the stepping motor 108 is rotated based on the detection result of the rotation detection circuit 110 (step S203).

When the control circuit 103 determines that the stepping motor 108 is not rotated in step S203, the control circuit 103 outputs a control signal to the main driving pulse generation circuit 104 so that the main driving pulse P1 is changed to the main driving pulse P1 with an energy increased by one rank (step S204). The main driving pulse generation circuit 104 generates the main driving pulse P1 having an energy increased by one rank and corresponding to the control signal from the control circuit 103, so that the stepping motor 108 is driven by this main driving pulse P1 in step S202 of the subsequent time.

Next, the control circuit 103 outputs a control signal to the correction driving pulse generation circuit 105 so that the stepping motor 108 is driven by the correction driving pulse P2 (step S205). The correction driving pulse generation circuit 105 generates the correction driving pulse P2 in response to the control signal so that the motor driver circuit 107 forcibly rotatably drives the stepping motor 108 by the correction driving pulse P2.

Next, the control circuit 103 determines whether the main driving pulse P1 with the energy increased by one rank is the main driving pulse P1 with a predetermined energy, that is, a main driving pulse P1k of a predetermined rank (over-discharge rank) indicating over-discharging of the secondary cell 113 (step S206). The main driving pulse P1k of the over-discharge rank is one driving pulse of the plurality of main driving pulses P1 and can be appropriately selected in accordance with a variation in the product characteristics. However, for example, a main driving pulse P1max of the maximum energy rank may be used as the main driving pulse P1k of the over-discharge rank.

When the control circuit 103 determines that the main driving pulse P1 is the main driving pulse P1k of the over-discharge rank in step S206, the control circuit 103 changes the over-discharge detection value to the second reference voltage (Hi) which is higher than the first reference voltage (step S207). Thus, in the process of step S201 of the subsequent time, it is determined whether the voltage of the secondary cell 113 is the high over-discharge detection value which is the second reference voltage. Therefore, when the voltage of the secondary cell 113 is lowered to the high over-discharge detection value, the irregular pointer movement of step S208 is performed. Accordingly, the over-discharging of the secondary cell 113 is detected before the stepping motor 108 is driven by the correction driving pulse P2. Thus, since the number of times of driving by the correction driving pulse P2 is reduced, the power consumption can be suppressed.

When the control circuit 103 determines that the main driving pulse P1 is not the main driving pulse P1k of the over-discharge rank in step S206 or the stepping motor 108 is rotated in step S203, the process returns to step S201.

Thus, since the driving of the stepping motor 108 by the correction driving pulse P2 can be avoided as far as possible, unnecessary energy consumption can be suppressed.

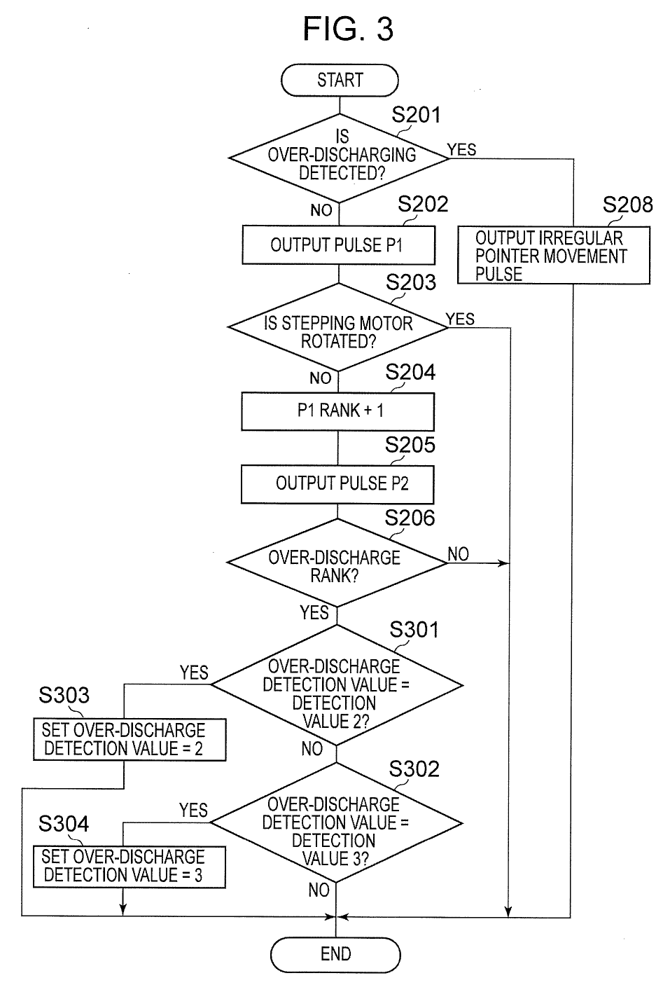

FIG. 3 is a flowchart illustrating the operations of the stepping motor control circuit and the analog electronic timepiece according to a second embodiment of the invention. The same reference numerals are given to the units performing the same processes in FIG. 2.

A block diagram of the second embodiment is the same as the block diagram of FIG. 1.

In the first embodiment, two kinds of voltages are provided as the over-discharge detection values. That is, the first reference voltage which is the low voltage and the second reference voltage which is higher than the first voltage are provided. The second embodiment is the same as the first embodiment in that a plurality of reference voltages are used.

In the second embodiment, however, three kinds of voltages are provided as the over-discharge detection values. That is, a predetermined lowest voltage (first reference voltage), a predetermined intermediate voltage (second reference voltage) higher than the lowest voltage, and a predetermined high voltage (third reference voltage) higher than the intermediate voltage are provided. Further, there is a difference when the reference voltage is changed.

Hereinafter, the differences from the first embodiment will be described with reference to FIGS. 1 and 3 according to the second embodiment of the invention.

The control circuit 103 determines whether the voltage detection circuit 112 detects a predetermined over-discharge detection value (step S201). In the initial state, the over-discharge detection value is set to the first reference voltage which is the lowest voltage.

When the control circuit 103 determines that the voltage of the secondary cell 113 is lowered to the first reference voltage in the initial state in step S201, the control circuit 103 outputs an irregular pointer movement pulse control signal to the irregular pointer movement pulse generation circuit 106 so that irregular pointer movement can be performed (step S208).

After determining that the voltage detection circuit 112 does not detect the over-discharge detection value in step S201, the control circuit 103 determines whether the current main driving pulse P1 is a main driving pulse P1k with an over-discharge rank (step S206). That is, the control circuit 103 determines whether the main driving pulse P1 with a rank increased in step S204 is the main driving pulse P1k. Here, the main driving pulse P1k with the over-discharge rank is the main driving pulse P1 with a predetermined energy. For example, the main driving pulse P1k is a main driving pulse P1max with the maximum energy.

When the control circuit 103 determines that the main driving pulse P1 is the main driving pulse P1k with the over-discharge rank in step S206, the control circuit 103 determines whether the over-discharge detection value, which is equal to or greater than the current voltage of the secondary cell 113 and is the closest to the current voltage of the secondary cell 113 detected by the voltage detection circuit 112, is the second reference voltage (step S301).

When the control circuit 103 determines that the over-discharge detection value, which is equal to or greater than the current voltage of the secondary cell 113 and is the closest to the current voltage of the secondary cell 113 detected by the voltage detection circuit 112, is not the second reference voltage in step S301, the control circuit 103 determines whether the over-discharge detection value, which is equal to or greater than the current voltage of the secondary cell 113 and is the closest to the current voltage of the secondary cell 113 detected by the voltage detection circuit 112, is the third reference voltage (step S302).

When the control circuit 103 determines that the over-discharge detection value, which is equal to or greater than the current voltage of the secondary cell 113 and is the closest to the current voltage of the secondary cell 113 detected by the voltage detection circuit 112, is not the third reference voltage in step S302, the process returns to step S201.

When the control circuit 103 determines that the over-discharge detection value, which is equal to or greater than the current voltage of the secondary cell 113 and is the closest to the current voltage of the secondary cell 113 detected by the voltage detection circuit 112, is the third reference voltage in step S302, the control circuit 103 sets the over-discharge detection value to the third reference voltage and the process returns to step S201 (step S304).

The subsequent process of determining whether the voltage of the secondary cell 113 reaches the over-discharge detection value (the process of step S201) is performed using the third reference voltage. Accordingly, since the stepping motor 108 is driven earlier by the irregular pointer movement pulse Ph at a voltage close to the driving limit voltage of the stepping motor 108, compared to the case where the over-discharge detection value is set to the first and second reference voltages, the number of times of driving by the correction driving pulse P2 is reduced.

When the control circuit 103 determines that the over-discharge detection value, which is equal to or greater than the current voltage of the secondary cell 113 and is the closest to the current voltage of the secondary cell 113 detected by the voltage detection circuit 112, is the second reference voltage in step S301, the control circuit 103 sets the over-discharge detection value to the second reference voltage and the process returns to step S201 (step S303).

The subsequent process of determining whether the voltage of the secondary cell 113 reaches the over-discharge detection value (the process of step S201) is performed using the second reference voltage. Accordingly, since the stepping motor 108 is driven earlier by the irregular pointer movement pulse Ph at a voltage close to the driving limit voltage of the stepping motor 108, compared to the case where the over-discharge detection value is set to the first reference voltage, the number of times of driving by the correction driving pulse P2 is reduced.

Thus, since the over-discharge detection value is changed to the reference voltage which is equal to or greater than the current voltage of the secondary cell 113 and is the closest to the current voltage of the secondary cell 113, it is possible to prevent the voltage of the secondary cell 113 from being changed to the unnecessarily high reference voltage (for example, changed directly from the first reference voltage to the third reference voltage). Therefore, it is possible to prevent the driving of the irregular pointer movement from being performed earlier irrespective of the fact that the voltage of the secondary cell 113 is high.

The over-discharge detection value is changed to one of the first to third reference voltage. Therefore, when the voltage of the secondary cell 113 is lowered, the over-discharge detection value is detected, the irregular pointer movement is performed, and the charging is prompted before occurrence of a situation where the stepping motor is driven by the correction driving pulse P2. Accordingly, since the driving by the correction driving pulse P2 can be avoided as far as possible, it is possible to obtain the advantage of suppressing unnecessary energy consumption.

In the second embodiment, the plural kinds of over-discharge detection values are provided. Therefore, when the control means selects the predetermined driving pulse P1k, the control means selects the over-discharge detection value, which is equal to or greater than the voltage of the secondary cell 113 and is the closest to the current voltage of the secondary cell 113, and gradually changes the setting. Accordingly, it is possible to set an optimum over-discharge detection value which is the closest to the driving limit voltage of the stepping motor 108.

In this embodiment, three kinds of over-discharge detection values have been used. However, more kinds of over-discharge detection values may be used.

As described above, the stepping motor control circuit according to the first and second embodiments includes at least the secondary cell 113 that serves as the power supply supplying the power to the stepping motor 108; the voltage detection circuit 112 that detects the voltage of the secondary cell 113; the rotation detection means for detecting the rotation state of the stepping motor 108; the control means for selecting the driving pulse depending on the rotation state of the stepping motor 108 among the plural kinds of driving pulses including at least the plural kinds of main driving pulses different from each other in energy and the correction driving pulse with the energy greater than each main driving pulse and for driving the stepping motor 108 in the predetermined pattern; and the announcement means for announcing that the voltage of the secondary cell 113 becomes the predetermined reference voltage when the voltage detection means detects that the voltage of the secondary cell 113 becomes the predetermined reference voltage. When the control means selects the predetermined main driving pulse P1k before the voltage detection circuit 112 detects that the voltage of the secondary cell 113 becomes the current reference voltage, the control means sets the reference voltage to the predetermined reference voltage higher than the current reference voltage.

The plural kinds of reference voltages are provided. Therefore, when the control means selects the predetermined main driving pulse P1k, the control means may set the predetermined main driving pulse P1k to the reference voltage which is equal to or greater than the voltage of the secondary cell detected by the voltage detection means and is the closest to the voltage of the secondary cell.

Further, the control means may drive the stepping motor 108 in the first pattern before the voltage detection circuit 112 detects that the voltage of the secondary cell 113 becomes the current reference voltage. In addition, the control means may drive the stepping motor 108 in the second pattern different from the first pattern when the voltage detection circuit 112 detects that the voltage of the secondary cell 113 becomes the current reference voltage.

Accordingly, since the driving by the correction driving pulse can be avoided as far as possible, unnecessary energy consumption can be suppressed.

When the stepping motor is driven by the main driving pulse P1k of the over-discharge rank before the detection of the over-discharge detection value, the over-discharge detection value may be made to change to a higher value, and thus the charging is prompted before the occurrence of the situation where the stepping motor is driven by the correction driving pulse P2. Thus, it is possible to prevent the occurrence of the situation where the stepping motor is driven by the correction driving pulse P2 as far as possible before the substitution with the irregular pointer movement, because the stepping motor is driven by the main driving pulse P1k of the over-discharge rank before the detection of the over-discharge detection value. Accordingly, before the main driving pulse P1k with the over-discharge rank is output, the over-discharge detection value can be detected and the change to the irregular pointer movement can be performed.

The analog electronic timepiece according to the above-described embodiments is configured as an analog electronic timepiece that includes the stepping motor rotatably driving time hands and a stepping motor control circuit controlling the stepping motor. The stepping motor control circuit is configured by the above-described stepping motor control circuit. Therefore, since the driving by the correction driving pulse can be avoided as far as possible, unnecessary energy consumption can be suppressed. Further, since the change to the irregular pointer movement is optimized, the duration time of the secondary cell 113 of the analog electronic timepiece can be lengthened.

Next, third to fifth embodiments of the invention will be described. Block diagrams of the third to fifth embodiments are the same as the block diagram of FIG. 1.

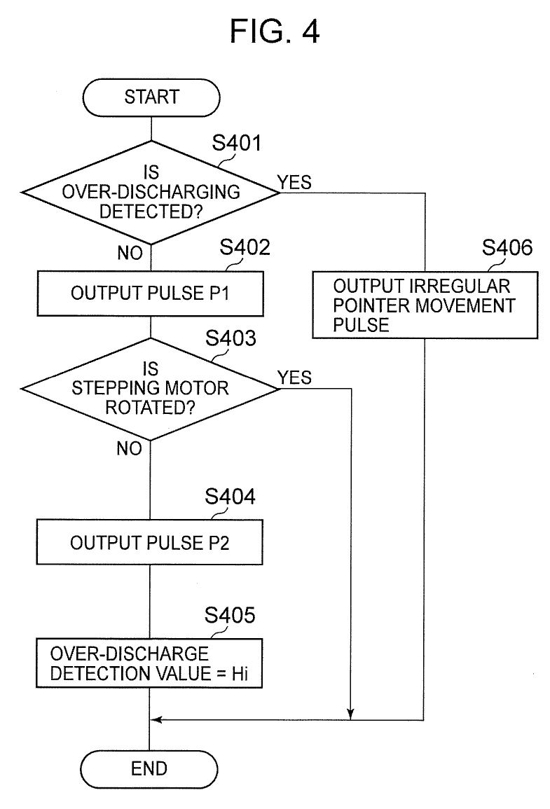

FIG. 4 is a flowchart illustrating the operations of the stepping motor control circuit and the analog electronic timepiece according to a third embodiment of the invention and is a flowchart mainly illustrating an operation when the control circuit 103 controls setting of an over-discharge detection value or the driving of the irregular pointer movement.

Hereinafter, an operation according to the third embodiment of the invention will be described in detail with reference to FIGS. 1 and 4.

The control circuit 103 controls the voltage detection circuit 112 such that the voltage detection circuit 112 detects the voltage of the secondary cell 113, when the stepping motor 108 is driven by the main driving pulse P1 in the first pattern of the period of one second to move the time hands.

The control circuit 103 determines whether the voltage detection circuit 112 detects a predetermined over-discharge voltage (over-discharge detection value) (step S401).

Here, the over-discharge detection value is a predetermined reference voltage used to determine whether the voltage of the secondary cell 113 is lowered to a predetermined voltage (the voltage of an over-discharge region).

The fact that the voltage detection circuit 112 detects the over-discharge detection value means that the voltage of the secondary cell 113 is lowered to the predetermined voltage (the voltage of the over-discharge region), and thus means that the voltage of the secondary cell 113 is lowered to a state where it is difficult to rotatably drive the stepping motor 108 normally only by the main driving pulse P1.

When the voltage of the secondary cell 113 is lowered to the over-discharge detection value, the stepping motor 108 may not be rotated by the main driving pulse P1, and thus is frequently driven by the correction driving pulse P2.

In the third embodiment, a plurality of reference voltages are provided as the over-discharge detection values. That is, two kinds of voltages are provided: a first reference voltage (Lo) which is a predetermined low voltage and a second reference voltage (Hi) which is a predetermined high voltage higher than the first reference voltage. These reference voltages are switched and set as the reference voltages used to detect whether the secondary cell 113 is in the over-discharge region. In the initial state, the over-discharge detection value of the first reference voltage is set.

When the control circuit 103 determines that the voltage detection circuit 112 detects the over-discharge detection value, that is, determines that the voltage of the secondary cell 113 is lowered to the first reference voltage in step S401, the control circuit 103 outputs an irregular pointer movement pulse control signal to the irregular pointer movement pulse generation circuit 106 so that irregular pointer movement is performed (step S406).

The irregular pointer movement pulse generation circuit 106 outputs the irregular pointer movement pulse Ph to the motor driver circuit 107 in response to the irregular pointer movement pulse control signal. The motor driver circuit 107 drives the stepping motor 108 by the irregular pointer movement pulse Ph to perform the irregular pointer movement in the second pattern different from the first pattern. For example, the second pattern can be configured as a pattern in which the stepping motor 108 performs the driving of the irregular pointer movement corresponding to two seconds every two seconds (two-second pointer movement).

Thus, when such irregular pointer movement is performed, a user is informed of the fact that the voltage of the secondary cell 113 is lowered to the predetermined voltage (the voltage of the over-discharge region) which is the driving limit. The user can reliably operate the analog electronic timepiece by radiating the solar cell 114 with solar light to generate power and charging the secondary cell 113 with the solar light.

When the voltage of the secondary cell 113 is lowered to a voltage equal to or less than the predetermined voltage, the stepping motor 108 is not rotated by the main driving pulse P1, but is rotated by the correction driving pulse P2, thereby increasing the power consumption. In the first embodiment, however, the user is informed of the lowering of the voltage by performing the irregular pointer movement when the voltage of the secondary cell 113 is lowered to the predetermined voltage, and charging is prompted. Therefore, since the number of times of driving by the correction driving pulse P2 can be reduced, lower power consumption can be realized.

When the control circuit 103 determines that the voltage detection circuit 112 does not detect the over-discharge value in step S401, the control circuit 103 outputs the control signal to the main driving pulse generation circuit 104 so that the main driving pulse generation circuit 104 outputs the main driving pulse P1 (step S402). The main driving pulse generation circuit 104 outputs the main driving pulse P1 with the energy corresponding to the control signal to the motor driver circuit 107, and the motor driver circuit 107 rotatably drives the stepping motor 108 by this main driving pulse P1 in the first pattern. The stepping motor 108 drives the analog display unit 109. The analog display unit 109 performs driving of the normal pointer movement to display a time.

The rotation detection circuit 110 detects the induction signal VRs generated by the rotation free oscillation of the stepping motor 108 in the rotation detection section T and outputs, to the control circuit 103, a detection signal indicating whether the induction signal VRs exceeding the reference threshold voltage Vcomp is detected, that is, whether the stepping motor 108 is rotated.

The control circuit 103 determines whether the stepping motor 108 is rotated based on the detection result of the rotation detection circuit 110 (step S403).

When the control circuit 103 determines that the stepping motor 108 is not rotated in step S403, the control circuit 103 outputs a control signal to the correction driving pulse generation circuit 105 so that the stepping motor 108 is driven by the correction driving pulse P2 (step S404). The correction driving pulse generation circuit 105 generates the correction driving pulse P2 in response to the control signal, so that the motor driver circuit 107 forcibly rotatably drives the stepping motor 108 by the correction driving pulse P2.

When plural kinds of main driving pulses P1 are used, the control circuit 103 may output a control signal to the main driving pulse generation circuit 104 so that the main driving pulse P1 is changed to the main driving pulse P1 with an energy increased by one rank at the subsequent driving time. In this case, the main driving pulse generation circuit 104 generates the main driving pulse P1 having an energy increased by one rank, so that the stepping motor 108 is driven by this main driving pulse P1 in step S402 of the subsequent time.

When the control circuit 103 selects the correction driving pulse P2 and drives the stepping motor 108, the control circuit 103 changes the over-discharge detection value to the second reference voltage (Hi) which is higher than the first reference voltage (step S405).

Thus, in the process of step S401 of the subsequent time, it is determined whether the voltage of the secondary cell 113 is the high over-discharge detection value which is the second reference voltage. Therefore, when the voltage of the secondary cell 113 is lowered to the high over-discharge detection value, the irregular pointer movement of step S406 is performed.

Accordingly, the over-discharging of the secondary cell 113 is detected before the stepping motor 108 is driven by the correction driving pulse P2. Thus, since the number of times of driving by the correction driving pulse P2 is reduced, the power consumption can be suppressed.

When the control circuit 103 determines that the stepping motor 108 is rotated in step S403, the process returns to step S401.

Thus, since the driving by the correction driving pulse P2 can be avoided as far as possible, unnecessary energy consumption can be suppressed.

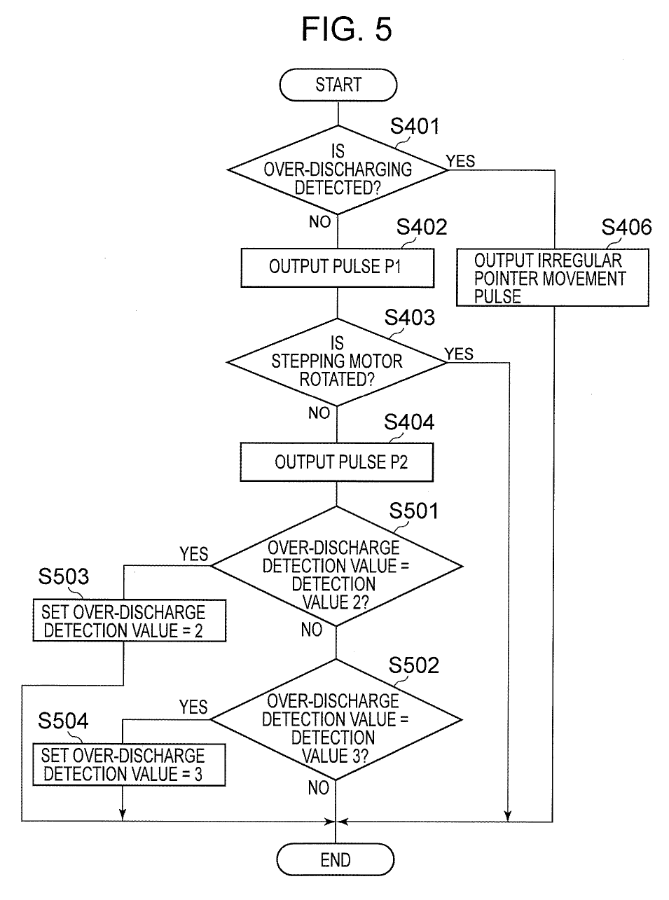

FIG. 5 is a flowchart illustrating the operations of the stepping motor control circuit and the analog electronic timepiece according to a fourth embodiment of the invention. The same reference numerals are given to the units performing the same processes in FIG. 4.

In the third embodiment, two kinds of voltages are provided as the over-discharge detection values. That is, the first reference voltage which is the low voltage and the second reference voltage which is higher than the first voltage are provided. The fourth embodiment is the same as the third embodiment in that a plurality of reference voltages are used.

In the fourth embodiment, however, three kinds of voltages are provided as the over-discharge detection values. That is, a predetermined lowest voltage (first reference voltage), a predetermined intermediate voltage (second reference voltage) higher than the lowest voltage, and a predetermined high voltage (third reference voltage) higher than the intermediate voltage are provided. Further, there is a difference when the reference voltage is changed.

Hereinafter, the differences from the third embodiment will be described with reference to FIGS. 1 and 5 according to the fourth embodiment of the invention.

The control circuit 103 determines whether the voltage detection circuit 112 detects a predetermined over-discharge detection value (step S401). In the initial state, the over-discharge detection value is set to the first reference voltage which is the lowest voltage.

When the control circuit 103 determines that the voltage of the secondary cell 113 is lowered to the first reference voltage in the initial state in step S401, the control circuit 103 outputs an irregular pointer movement pulse control signal to the irregular pointer movement pulse generation circuit 106 so that irregular pointer movement can be performed (step S406).

When the control circuit 103 determines that the voltage detection circuit 112 does not detect the over-discharge detection value in step S401 and then performs the driving by the correction driving pulse P2 in step S404, the control circuit 103 determines whether the over-discharge detection value, which is equal to or greater than the current voltage of the secondary cell 113 detected by the voltage detection circuit 112 and is the closest to the current voltage of the secondary cell 113, is the second reference voltage (step S501).

When the control circuit 103 determines that the over-discharge detection value, which is equal to or greater than the current voltage of the secondary cell 113 detected by the voltage detection circuit 112 and is the closest to the current voltage of the secondary cell 113, is not the second reference voltage in step S501, the control circuit 103 determines whether the over-discharge detection value, which is equal to or greater than the current voltage of the secondary cell 113 and is the closest to the current voltage of the secondary cell 113 detected by the voltage detection circuit 112, is the third reference voltage (step S502).

When the control circuit 103 determines that the over-discharge detection value, which is equal to or greater than the current voltage of the secondary cell 113 and is the closest to the current voltage of the secondary cell 113 detected by the voltage detection circuit 112, is not the third reference voltage in step S502, the process returns to step S401.

When the control circuit 103 determines that the over-discharge detection value, which is equal to or greater than the current voltage of the secondary cell 113 and is the closest to the current voltage of the secondary cell 113 detected by the voltage detection circuit 112, is the third reference voltage in step S502, the control circuit 103 sets the over-discharge detection value to the third reference voltage and the process returns to step S401 (step S504).

The subsequent process of determining whether the voltage of the secondary cell 113 reaches the over-discharge detection value (the process of step S401) is performed using the third reference voltage. Accordingly, since the stepping motor 108 is driven earlier by the irregular pointer movement pulse Ph at a voltage close to the driving limit voltage of the stepping motor 108, compared to the case where the over-discharge detection value is set to the first and second reference voltages, the number of times of driving by the correction driving pulse P2 is reduced.

When the control circuit 103 determines that the over-discharge detection value, which is equal to or greater than the current voltage of the secondary cell 113 and is the closest to the current voltage of the secondary cell 113 detected by the voltage detection circuit 112, is the second reference voltage in step S501, the control circuit 103 sets the over-discharge detection value to the second reference voltage and the process returns to step S401 (step S503).

The subsequent process of determining whether the voltage of the secondary cell 113 reaches the over-discharge detection value (the process of step S401) is performed using the second reference voltage. Accordingly, since the stepping motor 108 is driven earlier by the irregular pointer movement pulse Ph at a voltage close to the driving limit voltage of the stepping motor 108, compared to the case where the over-discharge detection value is set to the first reference voltage, the number of times of driving by the correction driving pulse P2 is reduced.

Thus, since the over-discharge detection value is changed to the reference voltage which is equal to or greater than the current voltage of the secondary cell 113 and is the closest to the current voltage of the secondary cell 113, it is possible to prevent the reference voltage from being changed to an unnecessarily higher reference voltage (for example, changed directly from the first reference voltage to the third reference voltage). Therefore, it is possible to prevent the driving of the irregular pointer movement from being performed earlier irrespective of the fact that the voltage of the secondary cell 113 is high.

The over-discharge detection value is changed to one of the first to third reference voltages. Therefore, when the voltage of the secondary cell 113 is lowered, the over-discharge detection value is detected, the irregular pointer movement is performed, and the charging is prompted before occurrence of a situation where the stepping motor is driven by the correction driving pulse P2. Accordingly, since the driving by the correction driving pulse P2 can be avoided as far as possible, it is possible to obtain the advantage of suppressing unnecessary energy consumption.

In the fourth embodiment, the plural kinds of over-discharge detection values are provided. Therefore, when the correction driving pulse P2 is selected and the stepping motor 108 is driven, the control means selects the reference voltage to the over-discharge detection value, which is equal to or greater than the voltage of the secondary cell 113 and is the closest to the current voltage of the secondary cell 113, and gradually changes the setting of the over-discharge detection values. Accordingly, it is possible to set an optimum over-discharge detection value which is the closest to the driving limit voltage of the stepping motor 108.

In this embodiment, three kinds of over-discharge detection values have been used. However, more kinds of over-discharge detection values may be used.

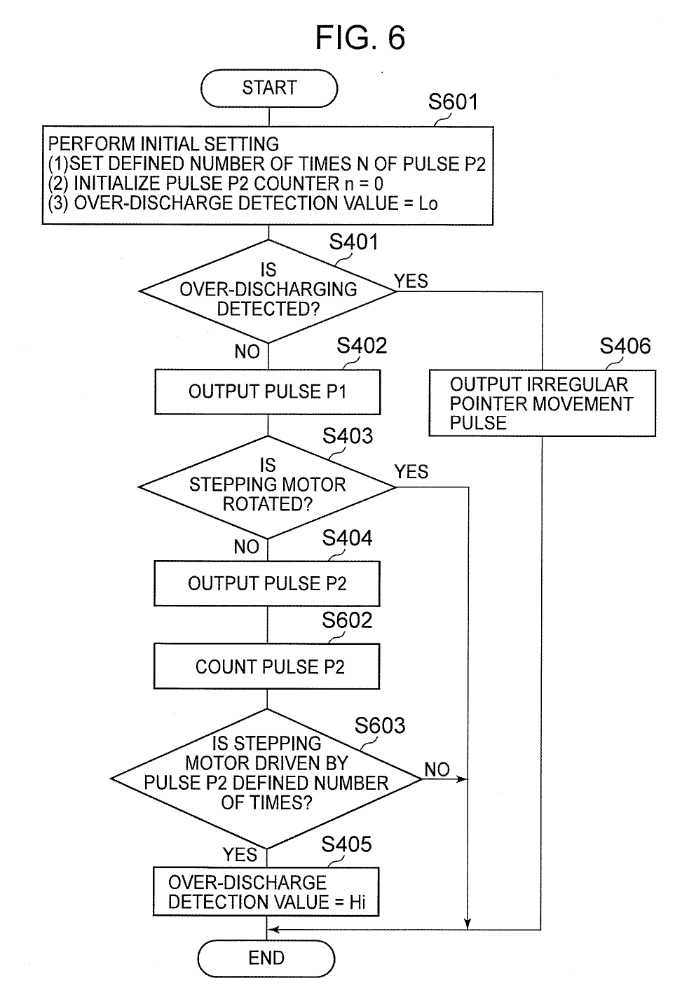

FIG. 6 is a flowchart illustrating the operations of the stepping motor control circuit and the analog electronic timepiece according to a fifth embodiment of the invention. The same reference numerals are given to the units performing the same processes in FIG. 4.

In the third embodiment, when the stepping motor 108 is driven once by the correction driving pulse P2, the setting of the over-discharge detection value is configured to be changed. In the fifth embodiment, however, when the stepping motor 108 is driven by the correction driving pulse P2 a predetermined number of times, the setting of the over-discharge detection value is configured to be changed.

In the fifth embodiment, an example will be described in which two kinds of reference voltages, that is, a first reference voltage which is a low voltage and a second reference voltage which is a voltage higher than the first reference voltage, are used as the over-discharge detection values, as in the third embodiment. However, as in the fourth embodiment, the setting of the over-discharge detection values may be changed using three or more over-discharge detection values.

Hereinafter, the differences from the third embodiment will be described with reference to FIGS. 1 and 6 according to the fifth embodiment of the invention.

The control circuit 103 first performs initial setting (step S601). In the initial setting, the control circuit 103 initializes a number count value n to 0 for the number of times of driving by the correction driving pulse P2 and sets the over-discharge detection value to a first reference voltage (Lo). The defined number of times which is the number of times of the correction driving pulse P2 is set in advance to N.

Even in the fifth embodiment, a plurality of reference voltages are provided as the over-discharge detection values, as in the third embodiment. That is, two kinds of reference voltages are provided: the first reference voltage (Lo) which is a predetermined low voltage and a second reference voltage (Hi) which is a predetermined voltage higher than the first reference voltage. These reference voltages are switched and set as the reference voltages used to detect whether the secondary cell 113 is in the over-discharge region. In the initial state, the over-discharge detection value of the first reference voltage (Lo) is set, as described above in step S601.

The control circuit 103 determines whether the voltage detection circuit 112 detects a predetermined over-discharge voltage (over-discharge detection value) (step S401).

When the control circuit 103 determines that the voltage detection circuit 112 detects the over-discharge detection value, that is, determines that the voltage of the secondary cell 113 is lowered to the first reference voltage in step S401, the control circuit 103 outputs an irregular pointer movement pulse control signal to the irregular pointer movement pulse generation circuit 106 so that irregular pointer movement is performed (step S406).

When the control circuit 103 determines that the voltage detection circuit 112 does not detect the over-discharge value in step S401, the control circuit 103 outputs the control signal to the main driving pulse generation circuit 104 so that the main driving pulse generation circuit 104 outputs the main driving pulse 21 (step S402). The main driving pulse generation circuit 104 outputs the main driving pulse 21 with the energy corresponding to the control signal to the motor driver circuit 107, and the motor driver circuit 107 drives the stepping motor 108 by this main driving pulse P1.

The control circuit 103 determines whether the stepping motor 108 is rotated based on the detection result of the rotation detection circuit 110 (step S403).

When the control circuit 103 determines that the stepping motor 108 is not rotated in step S403, the control circuit 103 outputs a control signal to the correction driving pulse generation circuit 105 so that the stepping motor 108 is driven by the correction driving pulse P2 (step S404). The correction driving pulse generation circuit 105 generates the correction driving pulse P2 in response to the control signal, so that the motor driver circuit 107 forcibly rotatably drives the stepping motor 108 by the correction driving pulse P2.

When plural kinds of main driving pulses P1 are used, the control circuit 103 may be configured to output a control signal to the main driving pulse generation circuit 104 so that the main driving pulse P1 is changed to the main driving pulse P1 with an energy increased by one rank at the subsequent driving time. In this case, the main driving pulse generation circuit 104 generates the main driving pulse P1 having an energy increased by one rank, so that the stepping motor 108 is driven by this main driving pulse P1 in step S402 of the subsequent time.

When the correction driving pulse P2 is selected and the stepping motor 108 is driven in step S404, the control circuit 103 adds 1 to the number count value of the number of times of driving by the correction driving pulse P2 (step S602).

When the control circuit 103 determines that the number of times of driving by the correction driving pulse P2 becomes the defined number of times N, that is, determines that the correction driving pulse P2 is selected and the stepping motor 108 is driven continuously a predetermined number of times (step S603), the control circuit 103 changes the over-discharge detection value to the second reference voltage (Hi) which is a voltage higher than the first reference voltage (step S405). Thus, in the process of step S401 of the subsequent time, it is determined whether the voltage of the secondary cell 113 is the high over-discharge detection value which is the second reference voltage. Therefore, when the voltage of the secondary cell 113 is lowered to the high over-discharge detection value, the irregular pointer movement of step S406 is performed. Accordingly, the over-discharging of the secondary cell 113 is detected before the stepping motor 108 is driven by the correction driving pulse P2. Thus, since the number of times of driving by the correction driving pulse P2 is reduced, the power consumption can be suppressed.

When the control circuit 103 determines that the stepping motor 108 is rotated in step S403, the process returns to step S401.

Thus, since the driving by the correction driving pulse P2 can be avoided as far as possible, unnecessary energy consumption can be suppressed.

When the stepping motor 108 is driven the predetermined number of times by the correction driving pulse P2, the setting of the over-discharge detection value is changed. The over-discharge detection value can be changed when the stepping motor 108 is driven by the steady correction driving pulse P2. Therefore, it is possible to prevent the over-discharge detection value from being changed due to an unexpected situation. Accordingly, it is possible to prevent the setting of the over-discharge detection value from being unnecessarily changed.

As described above, the stepping motor control circuit according to the third to fifth embodiments includes at least the secondary cell 113 that serves as the power supply supplying the power to the stepping motor 108; the voltage detection circuit 112 that detects the voltage of the secondary cell 113; the rotation detection means for detecting the rotation state of the stepping motor 108; the control means for selecting the driving pulse depending on the rotation state of the stepping motor 108 among the plural kinds of main driving pulses at least including the main driving pulse and the correction driving pulse with the energy greater than the main driving pulse and for driving the stepping motor 108 in the predetermined pattern; and the announcement means for announcing that the voltage of the secondary cell 113 becomes the predetermined reference voltage when the voltage detection means detects that the voltage of the secondary cell 113 becomes the predetermined reference voltage. When the control means selects the correction driving pulse and drives the stepping motor 108 before the voltage detection circuit 112 detects that the voltage of the secondary cell 113 becomes the current reference voltage, the control means sets the reference voltage to the predetermined reference voltage higher than the current reference voltage.

The plural kinds of reference voltages are provided. When the control means selects the correction driving pulse P2 for the driving, the control means may set the correction driving pulse P2 to a reference voltage which is equal to or greater than the voltage of the secondary cell 113 detected by the voltage detection circuit 112 and is the closest to the voltage of the secondary cell 113.

Further, the control means may drive the stepping motor 108 in the first pattern before the voltage detection circuit 112 detects that the voltage of the secondary cell 113 becomes the current reference voltage. In addition, the control means may drive the stepping motor 108 in the second pattern different from the first pattern when the voltage detection circuit 112 detects that the voltage of the secondary cell 113 becomes the current reference voltage.

Furthermore, when the control means selects the correction driving pulse P2 continuously a predetermined number of times before the voltage detection circuit 112 detects that the current voltage of the secondary cell 113 becomes the current reference voltage, the control means may change the setting of the reference voltage.

Accordingly, since the driving by the correction driving pulse can be avoided as far as possible, unnecessary energy consumption can be suppressed.

When the stepping motor is driven by the correction driving pulse P2 before the detection of the over-discharge detection value, the over-discharge detection value may be made to change to a higher value, and thus the charging is prompted before the occurrence of the situation where the stepping motor is driven by the correction driving pulse P2. Thus, it is possible to prevent the occurrence of the situation where the stepping motor is driven by the correction driving pulse P2 as far as possible before the substitution with the irregular pointer movement.

The analog electronic timepiece according to the above-described embodiment is configured as an analog electronic timepiece that includes the stepping motor rotatably driving time hands and the stepping motor control circuit controlling the stepping motor. The stepping motor control circuit is configured by the above-described stepping motor control circuit. Therefore, since the driving by the correction driving pulse can be avoided as far as possible, unnecessary energy consumption can be suppressed. Further, since the change to the irregular pointer movement is optimized, the duration time of the secondary cell 113 of the analog electronic timepiece can be lengthened.

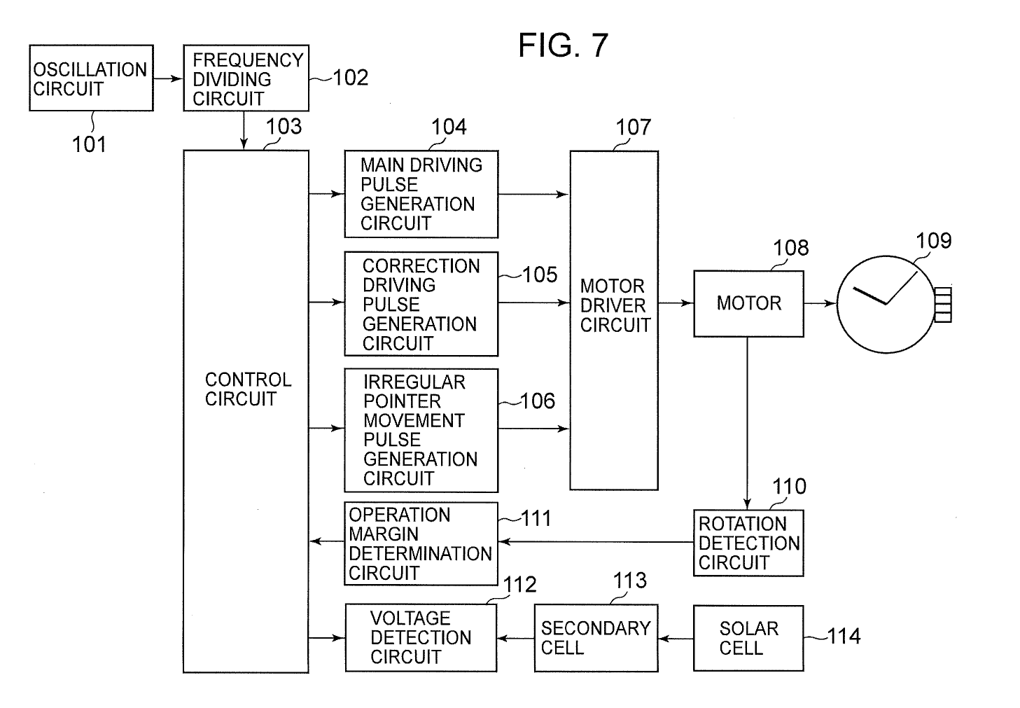

FIG. 7 is a common block diagram illustrating an analog electronic timepiece that uses a stepping motor control circuit according to sixth, seventh, twelfth, and thirteenth embodiments of the invention. FIG. 7 shows an example of an analog electronic wristwatch.

In FIG. 7, the analog electronic timepiece includes an oscillation circuit 101 that generates a signal with a predetermined frequency; a frequency dividing circuit 102 that divides the signal generated by the oscillation circuit 101 and generates a timepiece signal serving as a reference of time measurement; and a control circuit 103 that performs a time measurement process of the timepiece signal or various kinds of control such as control of each electronic circuit element of the analog electronic timepiece and change control of a driving pulse.

The analog electronic timepiece further includes a main driving pulse generation circuit 104 that selects and outputs a main driving pulse among plural kinds of main driving pulses P1 different from each other in energy based on a main driving pulse control signal from the control circuit 103; a correction driving pulse generation circuit 105 that outputs a correction driving pulse P2 with an energy greater than each of the main driving pulses P1 based on a correction driving pulse control signal from the control circuit 103; and an irregular pointer movement pulse generation circuit 106 that outputs an irregular pointer movement pulse Ph based on an irregular pointer movement pulse control signal from the control circuit 103. The irregular pointer movement pulse Ph is a driving pulse that has an energy greater than each of the main driving pulses P1 and smaller than the sum of one main driving pulse P1 and the correction driving pulse P2 (where the main driving pulse P1<the irregular pointer movement pulse Ph<(the main driving pulse P1+the correction driving pulse P2)). Further, one of the main driving pulses P1 may be used as the irregular pointer movement pulse.

The analog electronic timepiece further includes a motor driver circuit 107 that rotatably drives the stepping motor 108 in response to the main driving pulses P1 from the main driving pulse generation circuit 104, the correction driving pulse P2 from the correction driving pulse generation circuit 105, and the irregular pointer movement pulse Ph from the irregular pointer movement pulse generation circuit 106.

The analog electronic timepiece further includes a stepping motor 108 that is rotatably driven by the motor driver circuit 107; an analog display unit 109 that includes a display unit displaying time hands for time display or a calendar rotatably driven by the stepping motor 108; a rotation detection circuit 110 that detects an induction signal VRs generated by the stepping motor 108 in a predetermined rotation detection section and outputs a detection signal indicating a rotation state; and an operation margin determination circuit 111 that determines the degree of energy margin of a driving pulse by which the stepping motor 108 is rotatably driven based on the induction signal VRs detected by the rotation detection circuit 110.

The analog electronic timepiece further includes a secondary cell 113 serving as a power supply supplying power first to the stepping motor 108 and each electronic circuit element of the analog electronic timepiece, a solar cell 114 that charges the secondary cell 113, and a voltage detection circuit 112 that detects the voltage of the secondary cell 113. The secondary cell 113 functions as the power supply supplying the power to at least the stepping motor 108.

The oscillation circuit 101 and the frequency dividing circuit 102 form signal generation means. The analog display unit 109 forms announcement means. The rotation detection circuit 110 and the operation margin determination circuit 111 form rotation detection means. The solar cell 114 forms power generation means for generating power and also forms charging means for charging the secondary cell 113. The main driving pulse generation circuit 104, the correction driving pulse generation circuit 105, and the irregular pointer movement pulse generation circuit 106 form driving pulse generation means. The oscillation circuit 101, the frequency dividing circuit 102, the control circuit 103, the main driving pulse generation circuit 104, the correction driving pulse generation circuit 105, the irregular pointer movement pulse generation circuit 106, and the motor driver circuit 107 form control means. The oscillation circuit 101, the frequency dividing circuit 102, the control circuit 103, the main driving pulse generation circuit 104, the correction driving pulse generation circuit 105, the irregular pointer movement pulse generation circuit 106, the motor driver circuit 107, the rotation detection circuit 110, the operation margin determination circuit 111, the voltage detection circuit 112, the secondary cell 113, and the solar cell 114 form a stepping motor control circuit.

The solar cell 114 generates power to charge the secondary cell 113. The secondary cell 113 serving as the power supply supplies the power first to the stepping motor 108 and the circuit elements of the analog electronic timepiece, so that the analog electronic timepiece operates.

Each display operation of the analog electronic timepiece normally operating will be described in brief. In FIG. 7, the oscillation circuit 101 generates a signal with a predetermined frequency, divides the signal generated by the oscillation circuit 101 and the frequency dividing circuit 102 generates a timepiece signal (for example, a signal with a period of 1 second) serving as a reference of the time measurement and outputs the timepiece signal to the control circuit 103.

The control circuit 103 outputs a main driving pulse control signal to the main driving pulse generation circuit 104 in a predetermined period, so that the stepping motor 108 can be rotatably driven by the driving pulse of an energy rank corresponding to the magnitude of a load or the voltage of the secondary cell 113 in response to the timepiece signal.

In this embodiment, plural kinds of driving pulses are provided as driving pulses by which the stepping motor 108 is rotatably driven. Plural kinds (that is, plural ranks) of main driving pulses P1 different from each other in energy, an irregular pointer movement pulse Ph with an energy greater than each of the main driving pulses P1, and the correction diving pulse P2 with an energy greater than the irregular pointer movement pulse Ph are used as the driving pulses.

The main driving pulse P1 is a driving pulse used to rotatably drive the stepping motor 108 when time hands (second, minute, and hour pointers) are moved normally (the movement of the time hands in a predetermined period (first pattern) such as a period of one second). The correction driving pulse P2 is a driving pulse used to forcibly rotate the stepping motor 108 when the stepping motor 108 may not be rotated by the main driving pulse P1. The irregular pointer movement pulse is a driving pulse used to drive the movement of the time hands in a second pattern (for example, the stepping motor 108 performs driving of irregular pointer movement corresponding to two seconds every two seconds (two-second pointer movement)) different from the first pattern.

The main driving pulse generation circuit 104 outputs, to the motor driver circuit 107, the main driving pulse P1 of the energy rank corresponding to the main driving pulse control signal from the control circuit 103. The motor driver circuit 107 rotatably drives the stepping motor 108 by the main driving pulses P1. The stepping motor 108 is rotatably driven by the main driving pulses P1, so that the stepping motor 108 rotatably drives the time hands of the analog display unit 109. Thus, when the stepping motor 108 is normally rotated, the current time is displayed by the time hands in the analog display unit 109.

The rotation detection circuit 110 detects a detection signal VRs with a voltage exceeding a predetermined reference threshold voltage Vcomp among the induction signals VRs caused by rotation free oscillation of the stepping motor 108 in a predetermined detection section T.

The rotation detection circuit 110 is configured to detect the detection signal VRs with the voltage exceeding the predetermined reference threshold voltage Vcomp, when a rotor (not shown) of the stepping motor 108 performs a constant fast operation, for example, when the stepping motor 108 is rotated. On the other hand, the reference threshold voltage Vcomp is set so that the detection signal VRs does not exceed the predetermined reference threshold voltage Vcomp, when the rotor does not perform a constant fast operation, for example, when the stepping motor 108 is not rotated.

The operation margin determination circuit 111 compares a detection time of the induction signal VRs exceeding the reference threshold voltage Vcomp detected by the rotation detection circuit 110 with a detection section, determines a section in which the induction signal VRs is detected, and determines the degree of margin of the driving energy. In this embodiment, as described below, the detection section in which the rotation state of the stepping motor 108 is detected is divided into a plurality of sections.

In this way, the rotation detection circuit 110 detects the induction signal VRs exceeding the reference threshold voltage Vcomp generated by the stepping motor 108. The operation margin determination circuit 111 determines a section to which the induction signal VRs belongs among the detection sections and determines the driving margin of the driving pulse at that time based on the pattern indicating the section to which the induction signal VRs belongs.

Based on the driving margin of the driving pulse determined by the operation margin determination circuit 111, the control circuit 103 performs pulse control by outputting a control signal to the main driving pulse generation circuit 104 to perform an operation (pulse-up operation) of increasing the energy of the main driving pulse P1 by one rank or an operation (pulse-down operation) of decreasing the energy of the main driving pulse P1 by one rank. Alternatively, the control circuit 103 performs the pulse control by outputting the control signal to the correction driving pulse generation circuit 105 so that the stepping motor 108 is driven by the correction driving pulse P2.

The main driving pulse generation circuit 104 or the correction driving pulse generation circuit 105 outputs a driving pulse corresponding to the control signal to the motor driver circuit 107. The motor driver circuit 107 rotatably drives the stepping motor 108 by this driving pulse.

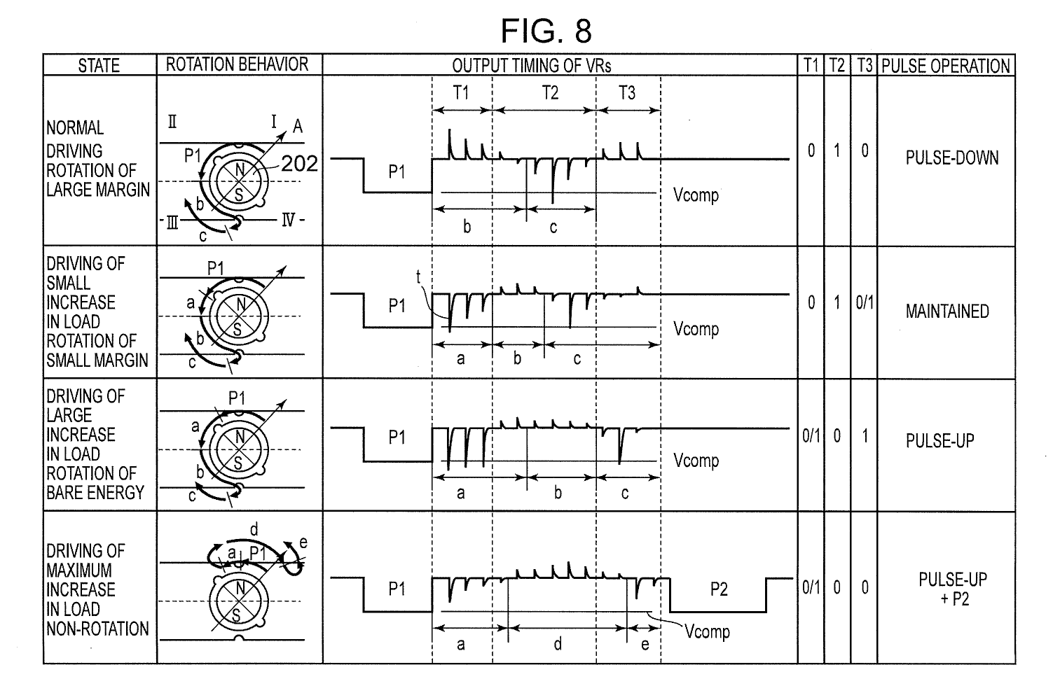

FIG. 8 is a diagram illustrating the timing when the stepping motor 108 is driven by the main driving pulse P1 according to the sixth, seventh, twelfth, and thirteenth embodiments of the invention. FIG. 8 shows the degree of margin of the driving pulse, the rotational position of a rotor 202 of the stepping motor 108, the pattern of the induction signal VRs indicating the rotation state, and a pulse control operation.

In FIG. 8, P1 denotes the main driving pulse 21 and also indicates a region in which the rotor 202 is rotatably driven by the main driving pulse P1 and a to e denote regions of the rotation position of the rotor 202 by the free oscillation after the stop of the driving by the main driving pulse P1.

A predetermined time immediately after the driving by the main driving pulse P1 is set to a first section T1, a predetermined time after the first section T1 is set to a second section T2, and a predetermined time after the second section T2 is set to a third section T3. Thus, the entire detection section T starts from the section immediately after the driving by the main driving pulse P1 is divided into the plurality of sections (in this embodiment, three sections T1 to T3). In this embodiment, a mask section, which is a section in which no induction signal VRs is detected, is not provided.

When the XY coordinate space, where the rotor 202 is a center and a main magnetic pole A of the rotor 202 is located by the rotation, is divided into the first quadrant I to the fourth quadrant IV, the first section T1 to the third section T3 can be expressed as follows.

That is, in a normal driving state (a rotation state where the margin of the driving energy is large), the first section T1 is a section in which a forward rotation state of the rotor 202 in the third quadrant III of the space where the rotor 202 is the center is determined, the second section T2 is a section in which the initial forward rotation state and the initial backward rotation state of the rotor 202 in the third quadrant III are determined, and the third section T3 is a section in which the rotation state after the initial backward rotation of the rotor 202 in the third quadrant III is determined. Here, the normal driving state is a state where the load driven in the normal time can be driven regularly by the main driving pulse P1. In this embodiment, the normal driving state is a state where the time hands can be regularly driven as the load by the main driving pulse P1.

In a state (a driving state where an increase in the load is small and a rotation state where the margin of the energy is small) where the driving energy is slightly smaller than the normal driving, the first section T1 is a section in which the forward rotation state of the rotor 202 in the second quadrant II is determined, the second section T2 is a section in which the initial forward rotation state and the initial backward rotation state of the rotor 202 in the third quadrant III are determined, and the third section T3 is a section in which the rotation state in the third quadrant III after the initial backward rotation state of the rotor 202 is determined.

In a state (a rotation state where the increase in the load is large and a rotation state where the energy is the maximum) where the driving energy is further smaller than the rotation state where the margin of the energy is small, the first section T1 is a section in which the forward rotation state of the rotor 202 in the second quadrant II is determined, the second section T2 is a section in which the forward rotation state of the rotor 202 in the second quadrant II and the initial forward rotation state of the rotor 202 in the third quadrant III are determined, and the third section T3 is a section in which the rotation state in the third quadrant III after the initial backward rotation state of the rotor 202 is determined.

In a state (a driving state where the increase in the load is the maximum and a non-rotation state where the energy is not sufficient) where the driving energy is further smaller than the rotation state where the energy is the maximum), the rotor 202 may not be rotated.

In FIG. 8, for example, in the normal driving state of the stepping motor control circuit according to this embodiment, the induction signal VRs generated in the region b is detected in the first section T1 and the induction signal VRs generated in the region c is detected in the first section T1 and the second section T2, and the induction signal VRs generated after the region c is detected in the third section T3.

On the assumption that a determination value “1” indicates a case where the rotation detection circuit 110 detects the induction signal VRs exceeding the reference threshold voltage Vcomp and a determination value indicates a case where the rotation detection circuit 110 may not detect the induction signal VRs exceeding the reference threshold voltage Vcomp, (0, 1, 0) is obtained as a pattern (a determination value in the first section, a determination value in the second section, and a determination value of the third section) indicating the rotation state in the normal driving example of FIG. 8. In this case, the control circuit 103 determines that the margin of the driving energy is large, decreases the driving energy by one rank (pulse-down), and performs pulse control so that the main driving pulse P1 is changed to the main driving pulse P1 of the driving energy decreased by one rank.

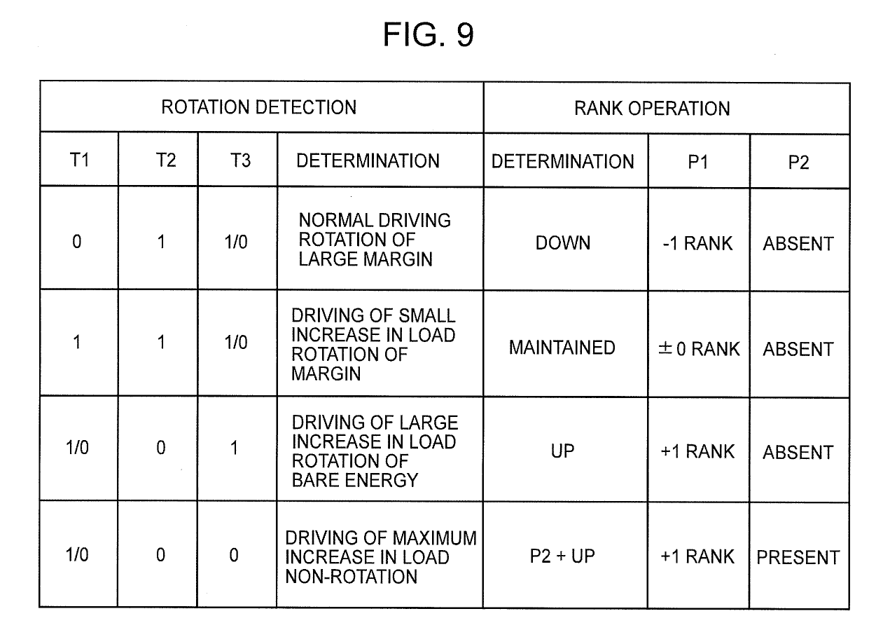

FIG. 9 is a diagram illustrating a determination chart of the pulse control operations according to the sixth, seventh, twelfth, and thirteenth embodiments of the invention. In FIG. 9, as described above, the determination value “1” indicates the case where the induction signal VRs exceeding the reference threshold voltage Vcomp is detected and the determination value “0” indicates the case where the induction signal VRs exceeding the reference threshold voltage Vcomp may not be detected. Further, a determination value “1/0” indicates any one of the determination values “1” and “0.”

As shown in FIG. 9, the rotation detection circuit 110 detects whether the induction signal VRs exceeding the reference threshold voltage Vcomp is present. The operation margin determination circuit 111 determines the degree of margin of the energy based on the pattern of the induction signal VRs. Referring to the determination chart of FIG. 9 stored inside the control circuit 103, the control circuit 103 performs the control, such as pulse-up or pulse-down of the main driving pulse P1 or the driving by the correction driving pulse P2, described below, and controls the rotation of the stepping motor 108.

For example, when a pattern is (1/0, 0, 0), the control circuit 103 determines that the stepping motor 108 is not rotated (non-rotation), controls the correction driving pulse generation circuit 105 so that the stepping motor 108 is driven by the correction driving pulse P2, and then controls the main driving pulse generation circuit 104 so that the driving pulse is changed to the main driving pulse P1 with an energy increased by one rank at the subsequent driving time for the driving.

When a pattern is (1/0, 0, 1), the stepping motor 108 is rotated. However, the driving energy is considerably low for the load. Therefore, the control circuit 103 determines that there is a concern that the stepping motor may be not rotated at the subsequent driving time, and thus controls the main driving pulse generation circuit 104. Then, the main driving pulse generation circuit 104 changes the main driving pulse P1 to the main driving pulse P1 with an energy increased by one rank at the subsequent driving time in advance, so that the stepping motor 108 is not driven by the correction driving pulse P2, but the stepping motor 108 is driven by the changed main driving pulse P1.

When a pattern is (1, 1, 1/0), the control circuit 103 determines that the stepping motor 108 is rotated and can be rotated at the subsequent driving time in spite of the fact that the margin of the driving energy is small for the load. The control circuit 103 controls the main driving pulse generation circuit 104 such that the main driving pulse generation circuit 104 does not change the main driving pulse P1 at the subsequent driving time for the driving.

When a pattern is (0, 1, 1/0), the control circuit 103 determines that the stepping motor 108 is rotated and the driving energy is excessive for the load. The control circuit 103 controls the main driving pulse generation circuit 104 such that the main driving pulse generation circuit 104 changes the main driving pulse P1 to the main driving pulse P1 with an energy deceased by one rank for the driving.

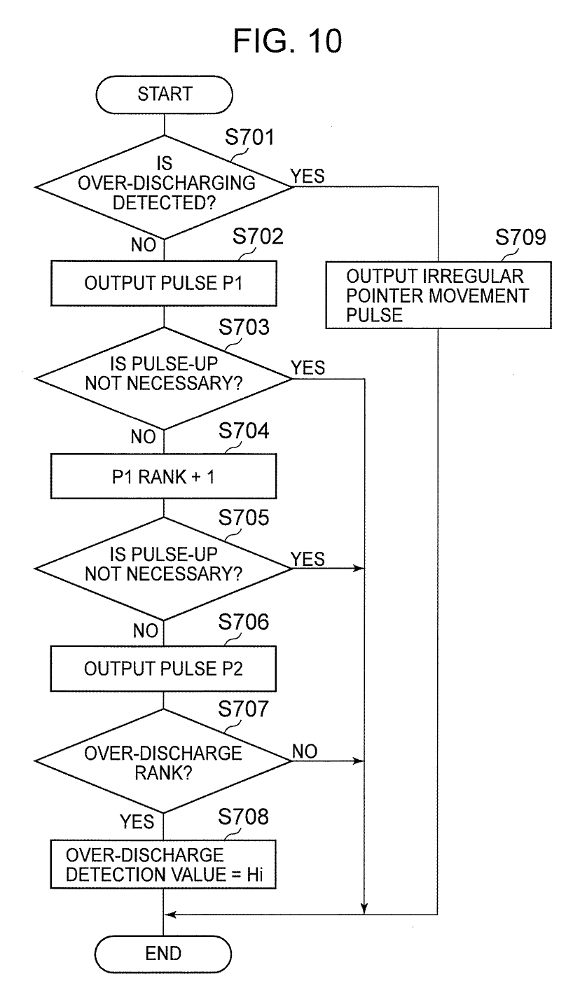

FIG. 10 is a flowchart illustrating the operations of the stepping motor control circuit and the analog electronic timepiece according to a sixth embodiment of the invention and is a flowchart mainly illustrating an operation of the control circuit 103.

Hereinafter, an operation of the sixth embodiment of the invention will be described in detail with reference to FIGS. 7 to 10.

The control circuit 103 controls the voltage detection circuit 112 such that the voltage detection circuit 112 detects the voltage of the secondary cell 113, when the stepping motor 108 is driven by the main driving pulse P1 in the first pattern of the period of one second to move the time hands.

When the control circuit 103 determines that the voltage detection circuit 112 detects a predetermined over-discharge detection value (step S701), the control circuit 103 outputs an irregular pointer movement pulse control signal to the irregular point movement pulse generation circuit 106 so that irregular pointer movement is performed (step S709).

Here, the over-discharge detection value is a reference voltage used to determine whether the voltage of the secondary cell 113 becomes a predetermined voltage (the voltage of an over-discharge region). In the sixth embodiment, a plurality of reference voltages are used as the over-discharge detection value. Two kinds of reference voltages are used. That is, a first reference voltage which is a predetermined low voltage and a second reference voltage which is higher than the first voltage are used. As described below, these reference voltages are switched and set as the reference voltages used to detect whether the secondary cell 113 is in the over-discharge region. The fact that the voltage detection circuit 112 detects the over-discharge detection value means that the voltage of the secondary cell 113 is lowered to the predetermined voltage (the voltage of the over-discharge region), and thus means that the voltage of the secondary cell 113 is lowered to a state where it is difficult to rotatably drive the stepping motor 108 normally only by the main driving pulse P1.

The irregular pointer movement pulse generation circuit 106 outputs the irregular pointer movement pulse Ph to the motor driver circuit 107 in response to the control signal. The motor driver circuit 107 drives the stepping motor 108 to perform the irregular pointer movement in the second pattern (for example, a two-second pointer movement). Thus, a user is informed of the fact that the voltage of the secondary cell 113 is lowered to the predetermined voltage (the voltage of the over-discharge region) which is the driving limit. The user can reliably operate the analog electronic timepiece by radiating the solar cell 114 with solar light to generate power and charging the secondary cell 113 with the solar light.

When the voltage of the secondary cell 113 is lowered to a voltage equal to or less than the predetermined voltage, the stepping motor 108 is not rotated by the main driving pulse P1, but is rotated by the correction driving pulse P2, thereby increasing the power consumption. In the sixth embodiment, however, the user is informed of the lowering of the voltage by performing the irregular pointer movement when the voltage of the secondary cell 113 is lowered to the predetermined voltage, and charging is prompted. Therefore, since the number of times of driving by the correction driving pulse P2 can be reduced, lower power consumption can be realized.

When the control circuit 103 determines that the voltage detection circuit 112 does not detect the over-discharge value in step S701, the control circuit 103 outputs a control signal to the main driving pulse generation circuit 104 so that the main driving pulse generation circuit 104 outputs the main driving pulse P1 (step S702). The main driving pulse generation circuit 104 outputs the main driving pulse P1 with the energy corresponding to the control signal to the motor driver circuit 107, and the motor driver circuit 107 rotatably drives the stepping motor 108 by this main driving pulse P1.

The rotation detection circuit 110 detects the induction signal VRs exceeding the reference threshold voltage Vcomp among the induction signals VRs generated by the rotation of the stepping motor 108 in the rotation detection section T. The operation margin determination circuit 111 generates a pattern of the induction signal VRs based on the induction signal VRs exceeding the reference threshold voltage Vcomp and determines the degree of margin of the driving energy.

The control circuit 103 determines whether pulse-up is not necessary based on the degree of margin determined by the operation margin determination circuit 111 (step S703).

When the control circuit 103 determines that the pulse-up is necessary in step S703 (when the driving energy is marginal for the rotation), the control circuit 103 controls the main driving pulse generation circuit 104 so that the main driving pulse P1 is increased by one rank (step S704). The main driving pulse generation circuit 104 outputs the main driving pulse P1 increased by one rank at the subsequent driving time to the motor driver circuit 107 in response to the control of the control circuit 103 and the motor driver circuit 107 rotatably drives the stepping motor 108 by the main driving pulse P1.

The rotation detection circuit 110 detects the induction signal VRs exceeding the reference threshold voltage Vcomp among the induction signals VRs generated by the rotation of the stepping motor 108 in the subsequent rotation detection section T. The operation margin determination circuit 111 generates a pattern of the induction signal VRs based on the induction signal VRs exceeding the reference threshold voltage Vcomp and determines the degree of margin of the driving energy.

The control circuit 103 determines whether pulse-up is not necessary based on the degree of margin determined by the operation margin determination circuit 111 (step S705).

When the control circuit 103 determines that the pulse-up is necessary in step S705 (the case of non-rotation), the control circuit 103 controls the correction driving pulse generation circuit 105 so that the stepping motor 108 is driven by the correction driving pulse P2 (step s706). The correction driving pulse generation circuit 105 outputs the correction driving pulse P2 to the motor driver circuit 107 in response to the control of the control circuit 103 and the motor driver circuit 107 rotatably drives the stepping motor 108 by the correction driving pulse P2.

Next, the control circuit 103 determines whether the rank of the current main driving pulse P1 is the over-discharge rank of the man driving pulse P1k (step S707). That is, the control circuit 103 determines whether the main driving pulse P1 by which the stepping motor 108 may not be rotated is the main driving pulse P1k with the over-discharge rank in step S704. Here, the main driving pulse P1k with the over-discharge rank is the main driving pulse P1 with a predetermined energy and is, for example, a main driving pulse P1max with the maximum energy.

When the control circuit 103 determines that the main driving pulse P1 is the main driving pulse P1k with the over-discharge rank in step S707, the control circuit 103 sets the over-discharge detection value to the second reference voltage (Hi) which is a high voltage and the process returns to step S701 (step S708). Thus, based on this second reference voltage, the control circuit 103 determines whether the voltage of the secondary cell 113 reaches the over-discharge detection value at the subsequent time. Accordingly, since the stepping motor 108 is driven by the irregular pointer movement pulse earlier compared to the case where the first reference voltage is set as the over-discharge detection value, the number of times of driving by the correction driving pulse P2 is reduced. Thus, the reduction in the power consumption is realized.

When the control circuit 103 determines that the current main driving pulse P1 is not the main driving pulse P1k with the over-discharge rank in step S707, determines that the pulse-up is not necessary in step S705, and determines that the pulse-up is not necessary in step S703, the process returns to step S701.

As described above, the stepping motor control circuit according to the sixth embodiment includes at least the secondary cell 113 that serves as the power supply supplying the power to the stepping motor 108; the voltage detection circuit 112 that detects the voltage of the secondary cell 113; the rotation detection means for detecting the rotation state of the stepping motor 108; the control means for selecting the driving pulse with the energy corresponding to the rotation state of the stepping motor 108 among the plural kinds of driving pulses and for driving the stepping motor 108 in the first pattern; and the announcement means for announcing that the voltage of the secondary cell 113 becomes the predetermined reference voltage when the voltage detection circuit 112 detects that the voltage of the secondary cell 113 becomes the predetermined reference voltage. When the control means determines that the pulse-up is necessary as the result of the selection of the predetermined driving pulse P1k and the driving, the control means sets the reference voltage to the reference voltage higher than the current reference voltage.

Here, the control means may drive the stepping motor 108 in the first pattern before the voltage detection circuit 112 detects that the voltage of the secondary cell 113 becomes the current reference voltage. In addition, the control means may drive the stepping motor 108 in the second pattern different from the first pattern when the voltage detection circuit 112 detects that the voltage of the secondary cell 113 becomes the current reference voltage.

In this way, it is determined whether the voltage of the secondary cell 113 reaches the voltage of the over-discharge region depending on the rotation state of the stepping motor by the main driving pulse P1, and the reference voltage which is a reference used to determined whether the voltage of the secondary cell 113 reaches the over-discharge voltage is switched. Further, when the main driving pulse P1k with the over-discharge pulse rank is set among the main driving pulses P1 with plural kinds of energies and the driving state of the stepping motor reaches a driving state (the state where the pulse-up is necessary) where there is no margin of the driving by the driving pulse P1k, it is determined that the correction driving pulse P2 is output before the detection of the over-discharge detection value and the over-discharge detection value is switched to the high voltage in order to prevent the correction driving pulse P2 from being output.

Accordingly, in the stepping motor control circuit according to the sixth embodiment, since the driving by the correction driving pulse P2 can be avoided as far as possible, unnecessary energy consumption can be suppressed.

Further, the lowering of the voltage is informed to further charge the secondary cell 113 by performing the irregular pointer movement when the voltage of the secondary cell 113 is lowered to the predetermined voltage. Therefore, since the number of times of driving by the correction driving pulse P2 can be reduced, low power consumption can be realized.

Further, since the change to the irregular pointer movement is optimized, the duration time of the secondary cell 113 can be lengthened.

The analog electronic timepiece according to the sixth embodiment is configured as an analog electronic timepiece that includes the stepping motor 108 rotatably driving time hands and a stepping motor control circuit controlling the stepping motor 108. The stepping motor control circuit controlling the stepping motor 108 is configured by the above-described stepping motor control circuit.

Thus, since the driving by the correction driving pulse P2 can be avoided as far as possible, it is possible to obtain the advantage of suppressing unnecessary energy consumption.

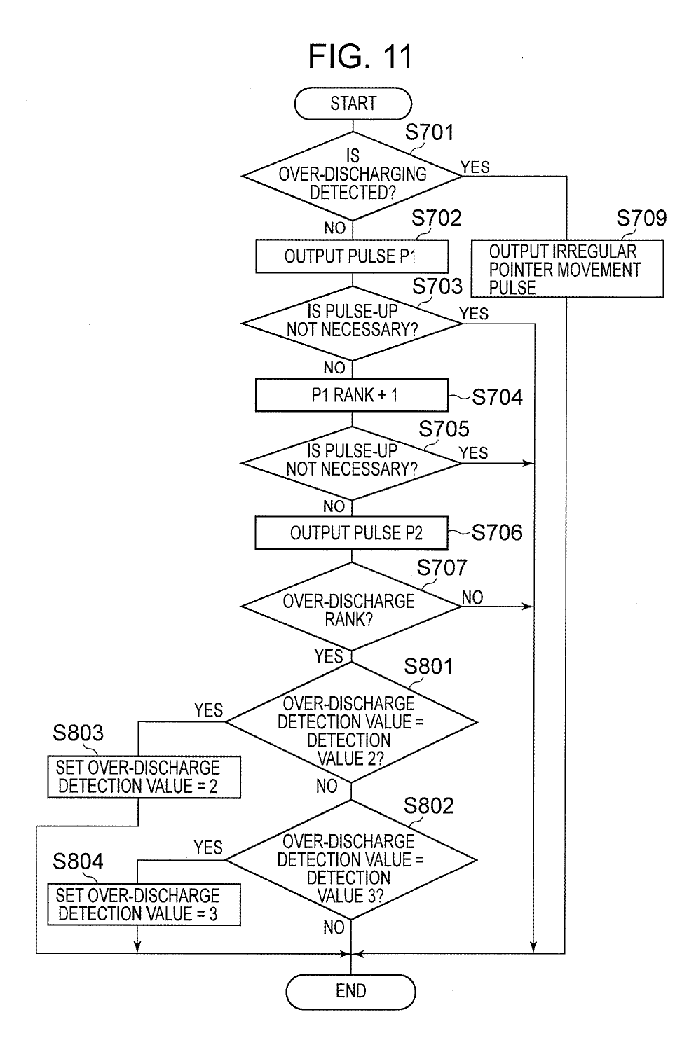

FIG. 11 is a flowchart illustrating the operations of the stepping motor control circuit and the analog electronic timepiece according to a seventh embodiment of the invention. The same reference numerals are given to the units performing the same processes in FIG. 10.

In the sixth embodiment, two kinds of voltages are provided as the over-discharge detection values. That is, the first reference voltage which is the low voltage and the second reference voltage which is higher than the first voltage are provided. The seventh embodiment is the same as the sixth embodiment in that a plurality of reference voltages are used.

In the seventh embodiment, however, three kinds of voltages are provided as the over-discharge detection values. That is, a predetermined lowest voltage (first reference voltage), a predetermined intermediate voltage (second reference voltage) higher than the lowest voltage, and a predetermined high voltage (third reference voltage) higher than the intermediate voltage are provided. Further, there is a difference when the reference voltage is changed.

Hereinafter, the differences from the sixth embodiment will be described with reference to FIGS. 7 to 9 and 11 according to the seventh embodiment of the invention.

The control circuit 103 determines whether the voltage detection circuit 112 detects a predetermined over-discharge detection value (step S701). The over-discharge detection value is a reference voltage used to determine whether the voltage of the secondary cell 113 becomes a predetermined voltage (the voltage of an over-discharge region). The three kinds of reference voltages are used. As described below, these reference voltages are switched and set as the reference voltages used to detect whether the secondary cell 113 is in the over-discharge region. Here, in the initial state, the over-discharge detection value is set to the first reference voltage which is the lowest voltage.

When the control circuit 103 determines that the voltage detection circuit 112 detects the first reference voltage set in the initial state in step S701, the control circuit 103 outputs an irregular pointer movement pulse control signal to the irregular point movement pulse generation circuit 106 so that irregular pointer movement is performed (step S709).

When the control circuit 103 determines that the first reference voltage is not detected in step S701 and then determines that the pulse-up is necessary even for the main driving pulse P1 with the energy increased by one rank (the case of non-rotation) in step S705, the control circuit 103 controls the correction driving pulse generation circuit 105 so that the stepping motor 108 is driven by the correction driving pulse P2 (step S706). The correction driving pulse generation circuit 105 outputs the correction driving pulse P2 to the motor driver circuit 107 in response to the control of the control circuit 103 and the motor driver circuit 107 rotatably drives the stepping motor 108 by the correction driving pulse P2.

Next, the control circuit 103 determines whether the rank of the current main driving pulse P1 is the over-discharge rank of the man driving pulse P1k (step S707). That is, the control circuit 103 determines whether the main driving pulse P1 by which the stepping motor 108 may not be rotated is the main driving pulse P1k with the over-discharge rank in step S704. Here, the main driving pulse P1k with the over-discharge rank is the main driving pulse P1 with a predetermined energy and is, for example, a main driving pulse P1max with the maximum energy.

When the control circuit 103 determines that the main driving pulse P1 is the main driving pulse P1k with the over-discharge rank in step S707, the control circuit 103 determines whether a reference voltage, which is higher than and is the closest to the current reference voltage, is the second reference voltage (step S801).

When the control circuit 103 determines that the reference voltage, which is higher than and is the closest to the current reference voltage, is the second reference voltage in step S801, the control circuit 103 sets the over-discharge detection value to the second reference voltage (step S803).

The determination process (the process of step S701) whether the voltage of the secondary cell 113 reaches the over-discharge detection value at the subsequent time is performed based on the second reference voltage. Accordingly, since the stepping motor 108 is driven by the irregular pointer movement pulse earlier by the irregular pointer movement pulse Ph at the voltage closer to the driving limit voltage of the stepping motor 108, compared to the case where the first reference voltage is set as the over-discharge detection value, the number of times of driving by the correction driving pulse P2 is reduced.

When the control circuit 103 determines that the reference voltage, which is higher than and is the closest to the current reference voltage, is not the second reference voltage in step S801, the control circuit 103 determines whether the reference voltage, which is higher than and is the closest to the current reference voltage, is the third reference voltage (step S802).

When the control circuit 103 determines that the reference voltage, which is higher than and is the closest to the current reference voltage, is the third reference voltage in step S802, the control circuit 103 sets the over-discharge detection value to the third reference voltage (step S804).

The determination process (the process of step S701) whether the voltage of the secondary cell 113 reaches the over-discharge detection value at the subsequent time is performed based on the third reference voltage. Accordingly, since the stepping motor 108 is driven by the irregular pointer movement pulse earlier by the irregular pointer movement pulse Ph at the voltage closer to the driving limit voltage of the stepping motor 108, compared to the case where the first or second reference voltage is set as the over-discharge detection value, the number of times of driving by the correction driving pulse P2 is reduced.

When the control circuit 103 determines that the reference voltage, which is higher than and is the closest to the current reference voltage, is not the third reference voltage in step S802, the process returns to step S701.

Thus, since the over-discharge detection value is changed to the reference voltage which is higher than and is the closest to the current reference voltage, it is possible to prevent the reference voltage from being changed to an unnecessary higher reference voltage (for example, changed directly from the first reference voltage to the third reference voltage). Therefore, it is possible to prevent the driving of the irregular pointer movement from being performed earlier irrespective of the fact that the voltage of the secondary cell 113 is high.

The over-discharge detection value is set to one of the first to third reference voltage. Therefore, when the voltage of the secondary cell 113 is lowered, the over-discharge detection value is detected, the irregular pointer movement is performed, and the charging is prompted before occurrence of a situation where the stepping motor is driven by the correction driving pulse P2. Accordingly, since the driving by the correction driving pulse P2 can be avoided as far as possible, it is possible to obtain the advantage of suppressing unnecessary energy consumption.

In the seventh embodiment, the plural kinds of over-discharge detection values are provided. Therefore, when the control means determines that the pulse-up is necessary as the result of the selection of the predetermined driving pulse P1k and the driving, the control means selects the over-discharge detection value, which is higher than and is the closest to the current over-discharge detection value, and gradually changes the setting of the over-discharge detection values. Accordingly, it is possible to set an optimum over-discharge detection value which is the closest to the driving limit voltage of the stepping motor 108.

In the seventh embodiment, three kinds of over-discharge detection values have been used. However, more kinds of over-discharge detection values may be used.

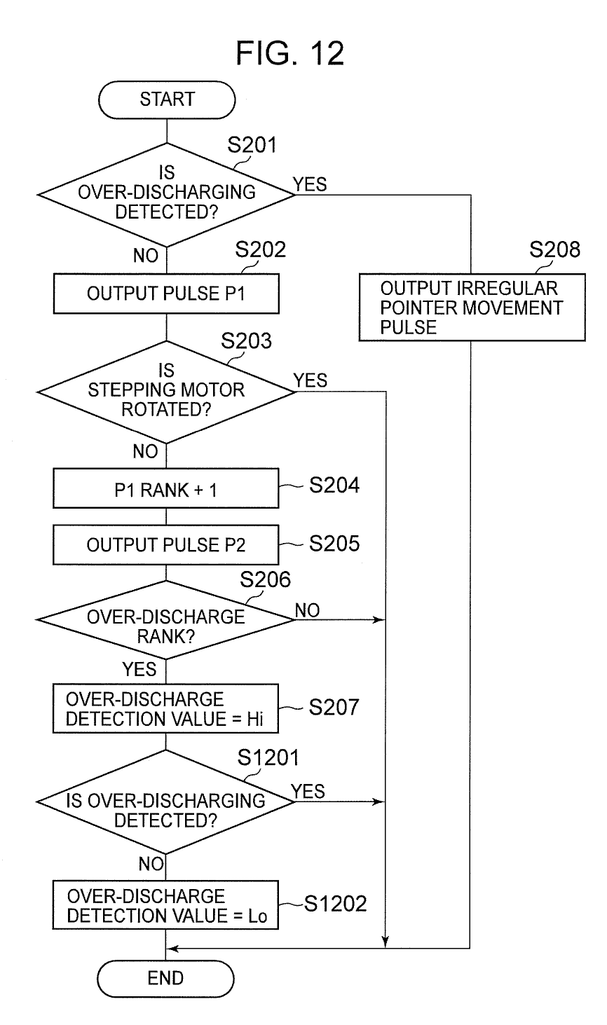

FIG. 12 is a flowchart illustrating the operations of the stepping motor control circuit and the analog electronic timepiece according to an eighth embodiment of the invention. The same reference numerals are given to the units performing the same processes in FIG. 2.

In the first embodiment, when the control means selects the predetermined main driving pulse before the voltage detection circuit 112 detects that the voltage of the secondary cell 113 becomes the current reference voltage, the control means sets the reference voltage to the predetermined reference voltage higher than the current reference voltage. In the eighth embodiment, however, when the control means determines that the voltage of the secondary cell 113 exceeds the predetermined reference voltage higher than the current reference voltage in a case where the control means drives the stepping motor 108 in a predetermined pattern (in the eighth embodiment, the control means selects the predetermined main driving pulse) before the voltage detection circuit 112 detects that the voltage of the secondary cell 113 becomes the current reference voltage, and the control means does not set the reference voltage to a predetermined reference voltage higher than the current reference voltage.

Hereinafter, the differences from the first embodiment will be described with reference to FIGS. 1 and 12 according to the eighth embodiment of the invention.

The control circuit 103 determines whether the main driving pulse P1 with the energy increased by one rank is the main driving pulse P1 with a predetermined energy in step S204, that is, a main driving pulse P1k of a predetermined rank (over-discharge rank) indicating over-discharging of the secondary cell 113 (step S206). The main driving pulse P1k of the over-discharge rank is one driving pulse of the plurality of main driving pulses P1 and can be appropriately selected in accordance with a variation in the product characteristics. However, for example, a main driving pulse P1max of the maximum energy rank may be used as the main driving pulse P1k of the over-discharge rank.

When the control circuit 103 determines that the main driving pulse P1 is the main driving pulse P1k of the over-discharge rank in step S206, the control circuit 103 changes the over-discharge detection value to the second reference voltage (Hi) which is higher than the first reference voltage (Lo) (step S207).

Next, when the control circuit 103 determines that the voltage detection circuit 112 does not detect the second reference voltage (Hi) which is the newly set over-discharge detection value, that is, the voltage of the secondary cell 113 is not a voltage equal to or less than the second reference voltage (step S1201), the control circuit 103 determines the current operation as a temporary load variation in a date-wheel driving operation or the like, returns the over-discharge detection value to the first reference voltage (Lo), and does not change the over-discharge detection value to the second reference voltage (Hi) (step S1202). Thus, since it is possible to prevent the over-discharge detection value from being unnecessarily changed, the voltage of the secondary cell 113 can be appropriately determined. Accordingly, since the number of times of driving by the correction driving pulse P2 is reduced, the power consumption is suppressed.

When the control circuit 103 determines that the voltage detection circuit 112 detects the second reference voltage (Hi), that is, the voltage of the secondary cell 113 is a voltage equal to or less than the second reference voltage (Hi) in step S1201, the control unit determines that the voltage of the secondary cell 113 is lowered, the control circuit 103 changes the reference voltage to the second reference voltage (Hi) and the process returns to step S201. Thus, in the process of step S201 of the subsequent time, it is determined whether the voltage of the secondary cell 113 is the high over-discharge detection value which is the second reference voltage. Therefore, when the voltage of the secondary cell 113 is lowered to the high over-discharge detection value, the irregular pointer movement of step S208 is performed. Accordingly, since the over-discharging of the secondary cell 113 is detected before the stepping motor 108 is driven by the correction driving pulse P2. Thus, since the number of times of driving by the correction driving pulse P2 is reduced, the power consumption can be suppressed.

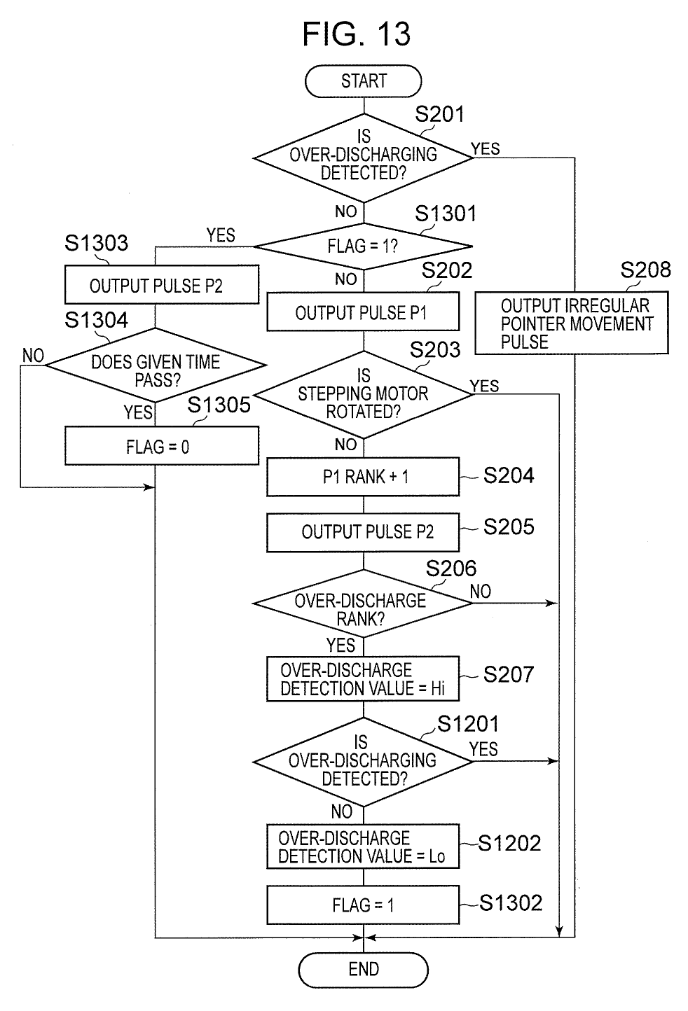

FIG. 13 is a flowchart illustrating the operations of the stepping motor control circuit and the analog electronic timepiece according to a ninth embodiment of the invention. The same reference numerals are given to the units performing the same processes in FIGS. 2 and 12.

Hereinafter, the differences from the eighth embodiment will be described with reference to FIGS. 1 and 13 according to the ninth embodiment of the invention.

When the control circuit 103 determines that the voltage detection circuit 112 detects that the voltage of the secondary cell 113 is not lowered to a voltage equal to or less than the over-discharge detection value (step S201), the control circuit 103 determines whether a flag indicating that a time passes is “1” (step S1301).

When the flag is not “1” (that is, when the flag is “0” and a predetermined time passes from the driving by the previous main driving pulse P1), the control circuit 103 performs the driving by the main driving pulse P1 (step S202), the processes of step S203 to step S207, step S1201, and step S1202 are performed, the flag is set to “1”, and then the process returns to step S201 (step S1302).

On the other hand, when the control circuit 103 determines that the flag is “1” (that is, when the predetermined time does not passes from the driving by the previous main driving pulse P1) in step S1301, the control circuit 103 controls the stepping motor 108 such that the stepping motor 108 is driven by the correction driving pulse P2 (step S1303). The motor driver circuit 107 drives the stepping motor 108 by the correction driving pulse P2.

Next, when the control circuit 103 determines that the flag is set to “1” in step S1302 and the predetermined time then passes (that is, the predetermined time passes from the driving by the previous main driving pulse P1) (step S1304), the flag is reset to “0” and the process returns to step S201 (step S1305). When the control circuit 103 determines that the predetermined time does not pass in step S1304, the process immediately returns to step S201.

In the ninth embodiment, as in the eighth embodiment, when the control means determines that the voltage of the secondary cell 113 exceeds the predetermined reference voltage higher than the current reference voltage in a case where the control means drives the stepping motor 108 in a predetermined pattern (in the ninth embodiment, the control means selects the predetermined main driving pulse) before the voltage detection circuit 112 detects that the voltage of the secondary cell 113 becomes the current reference voltage, the control means does not set the reference voltage to a predetermined reference voltage higher than the current reference voltage.

In the ninth embodiment, after the control means determines that the voltage of the secondary cell 113 exceeds the predetermined reference voltage higher than the current reference voltage in a case where the control means drives the stepping motor 108 in a predetermined pattern before the voltage detection circuit 112 detects that the voltage of the secondary cell 113 becomes the current reference voltage, the control means drives the stepping motor 108 by the correction driving pulse P2 instead of the main driving pulse P1 and drives the stepping motor 108 by the main driving pulse P1 whenever the predetermined time passes. When the rotation detection circuit 112 detects that the stepping motor 108 is rotated by the driving of the main driving pulse P1, the control means returns the driving pulse from the correction driving pulse P2 to the main driving pulse P1 and drives the stepping motor 108.

Accordingly, it is possible to obtain not only the same advantage as that of the eighth embodiment but also the advantage of normally rotatably driving the stepping motor even in an increase in the load, when the load temporarily varies, and reducing the power consumption by reducing the driving energy after a decrease in the load.

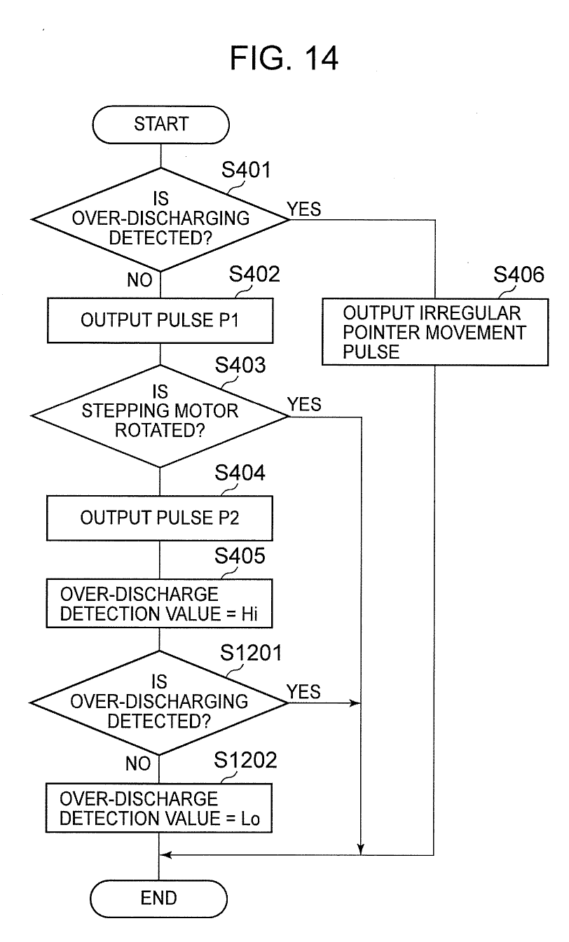

FIG. 14 is a flowchart illustrating the operations of the stepping motor control circuit and the analog electronic timepiece according to a tenth embodiment of the invention. The same reference numerals are given to the units performing the same processes in FIGS. 4 and 12.

Hereinafter, the differences from the third embodiment will be described with reference to FIGS. 1 and 14 according to the tenth embodiment of the invention.

After the stepping motor 108 is driven by the correction driving pulse P2 in step S404, the control circuit 103 changes the over-discharge detection value to the second reference voltage (Hi) which is a voltage higher than the first reference voltage (Lo) (step S405).

Next, when the control circuit 103 determines that the voltage detection circuit 112 does not detect the second reference voltage (Hi) which is the newly set over-discharge detection value, that is, the voltage of the secondary cell 113 is not lowered to a voltage equal to or less than the second reference voltage (Hi) (step S1201), the control circuit 103 determines the current operation as a temporary load variation in a date-wheel driving operation or the like, returns the over-discharge detection value to the first reference voltage (Lo), and does not change the reference voltage to the second reference voltage (Hi) (step S1202). Thus, since it is possible to prevent the over-discharge detection value from being unnecessarily changed, the voltage of the secondary cell 113 can be appropriately determined. Accordingly, since the number of times of driving by the correction driving pulse P2 is reduced, the power consumption is suppressed.

When the control circuit 103 determines that the voltage detection circuit 112 detects the second reference voltage (Hi), that is, the voltage of the secondary cell 113 is a voltage equal to or less than the second reference voltage (Hi) in step S1201, the control circuit 103 determines that the voltage of the secondary cell 113 is lowered, the control circuit 103 changes the reference voltage to the second reference voltage (Hi), and the process returns to step S401. Thus, in the process of step S401 of the subsequent time, it is determined whether the voltage of the secondary cell 113 is the high over-discharge detection value which is the second reference voltage. Therefore, when the voltage of the secondary cell 113 is lowered to the high over-discharge detection value, the irregular pointer movement of step S406 is performed. Accordingly, since the over-discharging of the secondary cell. 113 is detected before the stepping motor 108 is driven by the correction driving pulse P2. Thus, since the number of times of driving by the correction driving pulse P2 is reduced, the power consumption can be suppressed.

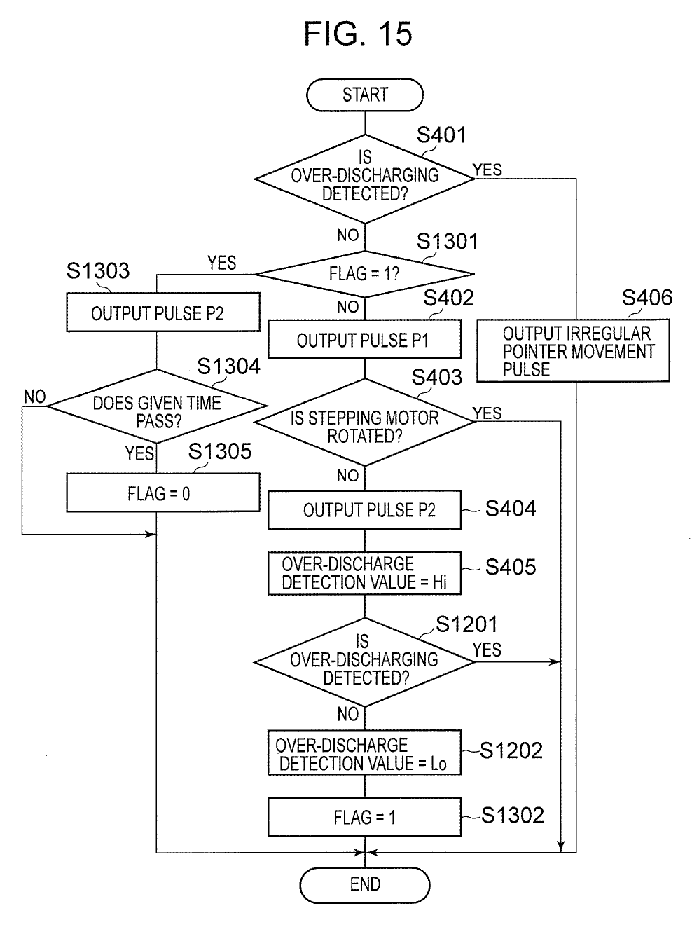

FIG. 15 is a flowchart illustrating the operations of the stepping motor control circuit and the analog electronic timepiece according to an eleventh embodiment of the invention. The same reference numerals are given to the units performing the same processes in FIGS. 4, 13, and 14.

Hereinafter, the differences from the tenth embodiment will be described with reference to FIGS. 1 and 15 according to the eleventh embodiment of the invention.

When the control circuit 103 determines that the voltage detection circuit 112 detect that the voltage of the secondary cell 113 is not lowered to a voltage equal to or less than the over-discharge detection value (step S401), the control circuit 103 determines whether a flag indicating that a time passes is “1” (step S1301).

When the control circuit 103 determines that the flag is not “1” in step S1301 (that is, when the control circuit 103 determines that the flag is “0” and a predetermined time passes from the driving by the previous main driving pulse P1), the processes of step S402 to step S405, step S1201, and step S1202 are performed, the flag is set to “1”, and then the process returns to step S401 (step S1302).

On the other hand, when the control circuit 103 determines that the flag is “1” (that is, when the predetermined time does not passes from the driving by the previous main driving pulse P1) in step S1301, the control circuit 103 controls the stepping motor 108 such that the stepping motor 108 is driven by the correction driving pulse P2 (step S1303). The motor driver circuit 107 drives the stepping motor 108 by the correction driving pulse P2.

Next, when the control circuit 103 determines that the flag is set to “1” in step S1302 and the predetermined time then passes (that is, the predetermined time passes from the driving by the previous main driving pulse P1) (step S1304), the flag is reset to “0” and the process returns to step S401 (step S1305). When the control circuit 103 determines that the predetermined time does not pass in step S1304, the process immediately returns to step S401.

In the eleventh embodiment, as in the tenth embodiment, when the control means determines that the voltage of the secondary cell 113 exceeds the predetermined reference voltage higher than the current reference voltage in a case where the control means drives the stepping motor 108 in a predetermined pattern (in the eleventh embodiment, the control means selects the correction driving pulse P2) before the voltage detection circuit 112 detects that the voltage of the secondary cell 113 becomes the current reference voltage, the control means does not set the reference voltage to a predetermined reference voltage higher than the current reference voltage.

In the eleventh embodiment, after the control means determines that the voltage of the secondary cell 113 exceeds the predetermined reference voltage higher than the current reference voltage in a case where the control means drives the stepping motor 108 in a predetermined pattern before the voltage detection circuit 112 detects that the voltage of the secondary cell 113 becomes the current reference voltage, the control means drives the stepping motor 108 by the correction driving pulse P2 instead of the main driving pulse P1 and drives the stepping motor 108 by the main driving pulse P1 whenever the predetermined time passes. When the rotation detection circuit 112 detects that the stepping motor 108 is rotated by the driving of the main driving pulse P1, the control means returns the driving pulse from the correction driving pulse P2 to the main driving pulse P1 and drives the stepping motor 108.

Accordingly, it is possible to obtain not only the same advantage as that of the tenth embodiment but also the advantage of normally rotatably driving the stepping motor even in an increase in the load, when the load temporarily varies, and reducing the power consumption by reducing the driving energy after a decrease in the load.

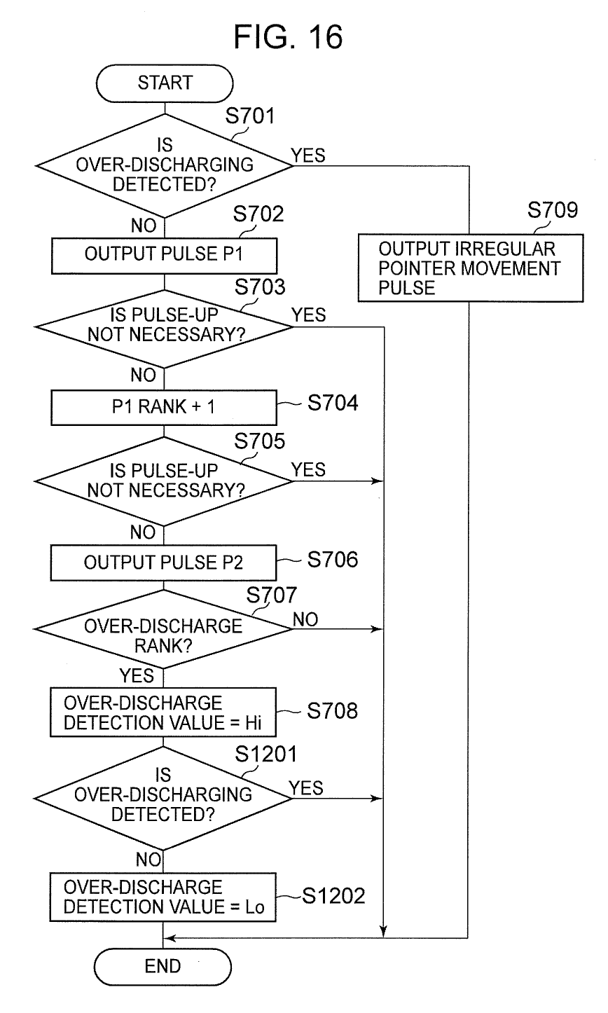

FIG. 16 is a flowchart illustrating the operations of the stepping motor control circuit and the analog electronic timepiece according to a twelfth embodiment of the invention. The same reference numerals are given to the units performing the same processes in FIGS. 10 and 12.

Hereinafter, the differences from the sixth embodiment will be described with reference to FIGS. 7 to 9 and 16 according to the twelfth embodiment of the invention.

The control circuit 103 determines whether the rank of the current main driving pulse P1 is the over-discharge rank of the man driving pulse P1k in step S707. That is, the control circuit 103 determines whether the main driving pulse P1 by which the stepping motor 108 may not be rotated is the main driving pulse P1k with the over-discharge rank in step S704. Here, the main driving pulse P1k with the over-discharge rank is the main driving pulse P1 with a predetermined energy and is, for example, a main driving pulse P1max with the maximum energy.

When the control circuit 103 determines that the main driving pulse P1 is the main driving pulse P1k with the over-discharge rank in step S707, the control circuit 103 sets the over-discharge detection value to the second reference voltage (Hi) which is a high voltage higher than the first reference voltage (Lo) (step S708).

Next, when the control circuit 103 determines that the voltage detection circuit 112 does not detect the second reference voltage (Hi) which is the newly set over-discharge detection value, that is, the voltage of the secondary cell 113 is not a voltage equal to or less than the second reference voltage (step S1201), the control circuit 103 determines the current operation as a temporary load variation in a date-wheel driving operation or the like, returns the over-discharge detection value to the first reference voltage (Lo), and does not change the over-discharge detection value to the second reference voltage (Hi) (step S1202). Thus, since it is possible to prevent the over-discharge detection value from being unnecessarily changed, the voltage of the secondary cell 113 can be appropriately determined. Accordingly, since the number of times of driving by the correction driving pulse P2 is reduced, the power consumption is suppressed.

When the control circuit 103 determines that the voltage detection circuit 112 detects the second reference voltage (Hi), that is, the voltage of the secondary cell 113 is a voltage equal to or less than the second reference voltage (Hi) in step S1201, the control circuit 103 changes the reference voltage to the second reference voltage (Hi) and the process returns to step S701. Thus, in the process of step S701 of the subsequent time, it is determined whether the voltage of the secondary cell 113 is the high over-discharge detection value which is the second reference voltage (Hi). Therefore, when the voltage of the secondary cell 113 is lowered to the high over-discharge detection value, the irregular pointer movement of step S709 is performed. Accordingly, since the over-discharging of the secondary cell 113 is detected before the stepping motor 108 is driven by the correction driving pulse P2. Thus, since the number of times of driving by the correction driving pulse P2 is reduced, the power consumption can be suppressed.

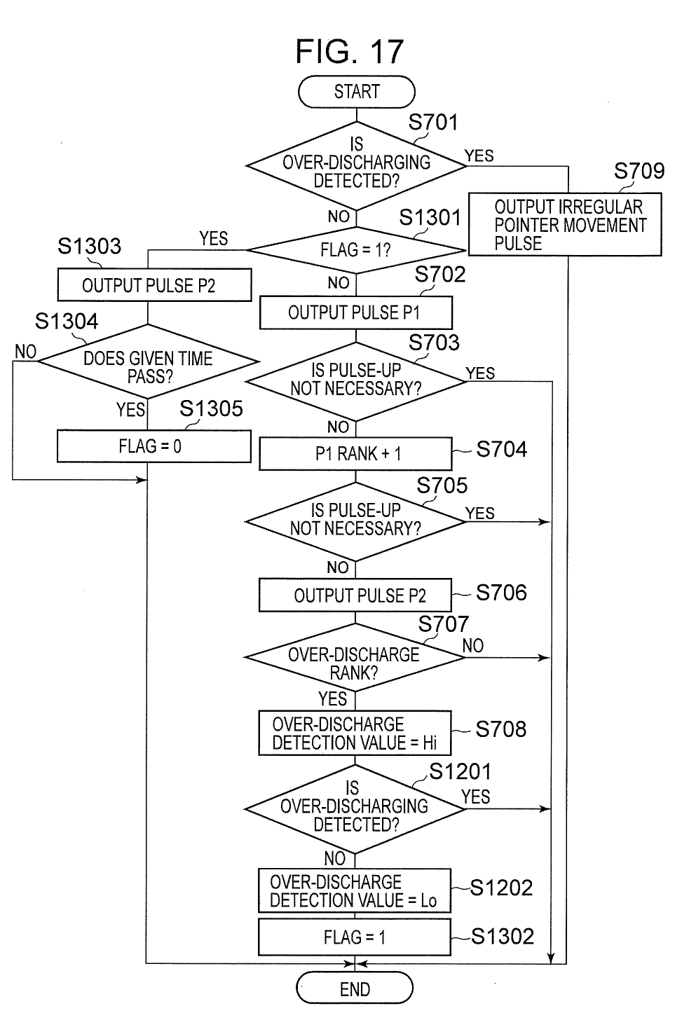

FIG. 17 is a flowchart illustrating the operations of the stepping motor control circuit and the analog electronic timepiece according to a thirteenth embodiment of the invention. The same reference numerals are given to the units performing the same processes in FIGS. 10 and 12.

Hereinafter, the differences from the twelfth embodiment will be described with reference to FIGS. 7 to 9 and 17 according to the thirteen embodiment of the invention.

When the control circuit 103 determines that the voltage detection circuit 112 detects that the voltage of the secondary cell 113 is not lowered to a voltage equal to or less than the over-discharge detection value (step S701), the control circuit 103 determines whether a flag indicating that a time passes is “1” (step S1301).

When the control circuit 103 determines that the flag is not “1” in step S1301 (that is, when the control circuit 103 determines that the flag is “0” and a predetermined time passes from the driving by the previous main driving pulse P1), the processes of step S702 to step S708, step S1201, and step S1202 are performed, the flag is set to “1”, and then the process returns to step S701 (step S1302).

On the other hand, when the control circuit 103 determines that the flag is “1” (that is, when the predetermined time does not passes from the driving by the previous main driving pulse P1) in step S1301, the control circuit 103 controls the stepping motor 108 such that the stepping motor 108 is driven by the correction driving pulse P2 (step S1303). The motor driver circuit 107 drives the stepping motor 108 by the correction driving pulse P2.

Next, when the control circuit 103 determines that the flag is set to “1” in step S1302 and the predetermined time then passes (that is, the predetermined time passes from the driving by the previous main driving pulse P1) (step S1304), the flag is reset to “0” and the process returns to step S701 (step S1305). When the control circuit 103 determines that the predetermined time does not pass in step S1304, the process immediately returns to step S701.

In the thirteenth embodiment, as in the twelfth embodiment, when the control means determines that the voltage of the secondary cell 113 exceeds the predetermined reference voltage higher than the current reference voltage in a case where the control means drives the stepping motor 108 in a predetermined pattern (in the thirteenth embodiment, the pattern of the induction signal VRs becomes a predetermined pattern) before the voltage detection circuit 112 detects that the voltage of the secondary cell 113 becomes the current reference voltage, the control means does not set the reference voltage to a predetermined reference voltage higher than the current reference voltage.

In the thirteenth embodiment, after the control means determines that the voltage of the secondary cell 113 exceeds the predetermined reference voltage higher than the current reference voltage in a case where the control means drives the stepping motor 108 in a predetermined pattern before the voltage detection circuit 112 detects that the voltage of the secondary cell 113 becomes the current reference voltage, the control means drives the stepping motor 108 by the correction driving pulse P2 instead of the main driving pulse P1 and drives the stepping motor 108 by the main driving pulse P1 whenever the predetermined time passes. When the rotation detection circuit 112 detects that the stepping motor 108 is rotated by the driving of the main driving pulse P1, the control means returns the driving pulse from the correction driving pulse P2 to the main driving pulse P1 and drives the stepping motor 108.

Accordingly, it is possible to obtain not only the same advantage as that of the twelfth embodiment but also the advantage of normally rotatably driving the stepping motor even in an increase in the load, when the load temporarily varies, and reducing the power consumption by reducing the driving energy after a decrease in the load.

As described above, the stepping motor control circuit according to each embodiment includes at least the secondary cell 113 that serves as the power supply supplying the power to the stepping motor 108; the voltage detection circuit 112 that detects the voltage of the secondary cell 113; the rotation detection means for detecting the rotation state of the stepping motor 108; the control means for selecting the driving pulse with the energy corresponding to the rotation state of the stepping motor 108 among the plural kinds of driving pulses and for driving the stepping motor 108 in a predetermined pattern; and the announcement means for announcing that the voltage of the secondary cell 113 becomes the predetermined reference voltage when the voltage detection circuit 112 detects that the voltage of the secondary cell 113 becomes the predetermined reference voltage. When the control means drives the stepping motor 108 before the voltage detection circuit 112 detects that the voltage of the secondary cell 113 becomes the current reference voltage, the control means sets the reference voltage to the predetermined reference voltage higher than the current reference voltage.

Here, when the control means determines that the voltage of the secondary cell 113 exceeds the predetermined reference voltage higher than the current reference voltage in a case where the control means drives the stepping motor 108 in a predetermined pattern before the voltage detection circuit 112 detects that the voltage of the secondary cell 113 becomes the current reference voltage, the control means does not set the reference voltage to the predetermined reference voltage higher than the current reference voltage.

After the control means determines that the voltage of the secondary cell 113 exceeds the predetermined reference voltage higher than the current reference voltage in the case where the control means drives the stepping motor 108 in the predetermined pattern before the voltage detection circuit 112 detects that the voltage of the secondary cell 113 becomes the current reference voltage, the control means drives the stepping motor 108 by the correction driving pulse P2 instead of the main driving pulse P1 and drives the stepping motor 108 in a predetermined time interval by the main driving pulse P1. When the rotation detection means detects the stepping motor 108 is rotated by the driving by the main driving pulse P1, the control means changes the driving pulse from the correction driving pulse P2 to the main driving pulse P1 and drives the stepping motor 108.

An analog electronic timepiece according to the invention includes a stepping motor rotatably driving a time hand and a stepping motor control circuit controlling the stepping motor. The stepping motor control circuit described in any one of the embodiments is used as this stepping motor control circuit.

In the stepping motor control circuit according to each embodiment, since the driving by the correction driving pulse can be avoided as far as possible, unnecessary energy consumption can be suppressed.

In the analog electronic timepiece according to each embodiment of the invention, since the driving by the correction driving pulse can be avoided as far as possible, it is possible to obtain the advantage of suppressing unnecessary energy consumption.

In each embodiment described above, the solar cell 114 is included in the analog electronic timepiece as means for charging the secondary cell 113. However, charging means, such as the automatic winding charging means or manual winding charging means, other than the solar cell 114 may be used and the charging means may be separate from the analog electronic timepiece.

Further, the stepping motor described above is applicable to a stepping motor that drives others other than time hands or a calendar.

An electronic timepiece has been examples as an application example of the stepping motor, but the stepping motor is applicable to an electronic apparatus using a motor.

The stepping motor control circuit according to the invention is applicable to various electronic apparatuses using a stepping motor.

Further, the electronic timepiece according to the invention is applicable to various analog electronic timepieces such as an analog electronic timepiece, which has a calendar function, such as an analog electronic wristwatch having a calendar function, an analog electronic clock having a calendar function.

What is claimed is:

1. A stepping motor control circuit comprising:
a secondary cell serving as a power supply that supplies power at least to a stepping motor;
voltage detection means for detecting a voltage of the secondary cell;
rotation detection means for detecting a rotation state of the stepping motor;
control means for selecting a driving pulse of an energy corresponding to the rotation state of the stepping motor from plural kinds of driving pulses and driving the stepping motor in a predetermined pattern; and
announcement means for announcing that the voltage of the secondary cell becomes a predetermined reference voltage when the voltage detection means detects that the voltage of the secondary cell becomes the predetermined reference voltage,
wherein when the control means drives the stepping motor in the predetermined pattern before the voltage detection means detects that the voltage of the secondary cell becomes a current reference voltage, the control means sets the reference voltage to the predetermined reference voltage higher than the current reference voltage.

2. The stepping motor control circuit according to claim 1,
wherein the control means selects the driving pulse in accordance with the rotation state of the stepping motor among the plural kinds of driving pulses at least including plural kinds of main driving pulses different from each other in energy and a correction driving pulse with an energy greater than each of the main driving pulses and drives the stepping motor in the predetermined pattern, and
wherein when the control means selects a predetermined main driving pulse before the voltage detection means detects that the voltage of the secondary cell becomes the current reference voltage, the control means sets the reference voltage to the predetermined reference voltage higher than the current reference voltage.

3. The stepping motor control circuit according to claim 2,
wherein the reference voltage includes plural kinds of reference voltages, and
wherein when the control means selects the predetermined main driving pulse, the control means sets the reference voltage to a reference voltage which is equal to or greater than and is the closest to the voltage of the secondary cell detected by the voltage detection means.

4. The stepping motor control circuit according to claim 1,
wherein the control means selects the driving pulse in accordance with the rotation state of the stepping motor among the plural kinds of driving pulses at least including the main driving pulse and a correction driving pulse with an energy greater than the main driving pulse and drives the stepping motor in the predetermined pattern, and
wherein when the control means selects the correction driving pulse for the driving before the voltage detection means detects that the voltage of the secondary cell becomes the current reference voltage, the control means sets the reference voltage to the predetermined reference voltage so as to be higher than the current reference voltage.

5. The stepping motor control circuit according to claim 4,
wherein the reference voltage includes plural kinds of reference voltages, and
wherein when the control means selects the correction driving pulse and drives the stepping motor, the control means sets the reference voltage to a reference voltage which is equal to or greater than and is the closest to the voltage of the secondary cell detected by the voltage detection means.

6. The stepping motor control circuit according to claim 4, wherein when the control means selects the correction driving pulse continuously a predetermined number of times for the driving before the voltage detection means detects that the voltage of the secondary cell is the current reference voltage, the control means changes the setting of the reference voltage.

7. The stepping motor control circuit according to claim 5, wherein when the control means selects the correction driving pulse continuously a predetermined number of times for the driving before the voltage detection means detects that the voltage of the secondary cell is the current reference voltage, the control means changes the setting of the reference voltage.

8. The stepping motor control circuit according to claim 1,
wherein the control means selects the driving pulse with an energy corresponding to the rotation state of the stepping motor among the plural kinds of driving pulses and drives the stepping motor in the predetermined pattern, and
wherein when the control means determines that pulse-up is necessary as a result of the selection of the predetermined driving pulse and the driving, the control means sets the reference voltage to the predetermined reference voltage higher than the current reference voltage.

9. The stepping motor control circuit according to claim 8,
wherein the reference voltage includes plural kinds of reference voltages, and
wherein when the control means determines that the pulse-up is necessary as the result of the selection of the predetermined driving pulse and the driving, the control means sets the reference voltage to a reference voltage which is higher than and is the closest to the current reference voltage.

10. The stepping motor control circuit according to claim 8, wherein the control means determines whether the pulse-up is necessary for an induction signal exceeding a reference threshold voltage generated by the stepping motor in accordance with a driving margin detected by the rotation detection means and determined by a time after the driving as the result of the selection of the predetermined driving pulse and the driving.

11. The stepping motor control circuit according to claim 9, wherein the control means determines whether the pulse-up is necessary for an induction signal exceeding a reference threshold voltage generated by the stepping motor in accordance with a driving margin detected by the rotation detection means and determined by a time after the driving as the result of the selection of the predetermined driving pulse and the driving.

12. The stepping motor control circuit according to claim 1, wherein the control means drives the stepping motor in the first pattern before the voltage detection means detects that the voltage of the secondary cell becomes the current reference voltage, and
wherein when the voltage detection means detects that the voltage of the secondary cell becomes the current reference voltage, the control means drives the stepping motor in a second pattern different from the first pattern.

13. The stepping motor control circuit according to claim 1, wherein when the control means determines that the voltage of the secondary cell exceeds the predetermined reference voltage higher than the current reference voltage in a case where the control means drives the stepping motor in a predetermined pattern before the voltage detection means detects that the voltage of the secondary cell becomes the current reference voltage, the control means does not set the reference voltage to the predetermined reference voltage higher than the current reference voltage.

14. The stepping motor control circuit according to claim 13,
wherein after the control means determines that the voltage of the secondary cell exceeds the predetermined reference voltage higher than the current reference voltage in the case where the control means drives the stepping motor in the predetermined pattern before the voltage detection means detects that the voltage of the secondary cell becomes the current reference voltage, the control means drives the stepping motor by the correction driving pulse instead of the main driving pulse and drives the stepping motor in a predetermined time interval by the main driving pulse, and
wherein when the rotation detection means detects the stepping motor is rotated by the driving by the main driving pulse, the control means changes the driving pulse from the correction driving pulse to the main driving pulse and drives the stepping motor.

15. An analog electronic timepiece comprising:
a stepping motor rotatably driving a time hand; and
a stepping motor control circuit controlling the stepping motor,
wherein the stepping motor control circuit is the stepping motor control circuit according to claim 1.
